(19) United States
(12) Patent Application Publication
(10) Pub. No.: US 2026/0326860 A1
(43) Pub. Date: Oct. 22, 2026

(54) MODULAR POWERED SURFBOARD

(71) Applicant: Lind Art & Technology AB, BROMMA (SE)

(72) Inventor: Jeffrey FRIESEN, FOLSOM, CA (US)

(21) Appl. No.: 19/711,064

(22) Filed: Jun. 17, 2026

Related U.S. Application Data
(63) Continuation of application No. PCT/EP2024/087112, filed on Dec. 18, 2024.

(30) Foreign Application Priority Data
Dec. 21, 2023 (SE) 2351471-4
Dec. 21, 2023 (SE) 2351473-0
Dec. 21, 2023 (SE) 2351474-8

(51) Int. Cl. B63B 32/10

(52) U.S. Cl. CPC B63B 32/10

(57) ABSTRACT

A powered surfboard system includes a hull with a forward-rearward axis and a lower side, and a propulsion system having a battery pack and a water jet module releasably attached to the hull. The battery pack, which has a rechargeable battery and a battery pack housing, powers the water jet module. The lower side of the hull has a recess receiving the battery pack and water jet module such that part of the battery pack housing is at least partly submerged in water when the surfboard is ridden. The battery pack is arranged forward of the water jet module in the recess. A first electrical connector on a rearward-protruding part of the battery pack mates with a second electrical connector on a forward-protruding part of the water jet module. The rearward-protruding part is arranged below the forward-protruding part when the hull is oriented for riding in water.

### BACKGROUND

Electric surfboards are often powered with a rechargeable battery. Such a battery may sometimes be releasably attachable to the rest of the system for charging and in order to facilitate transport and for easy replacement during charging cycles. However, there is a need for improved modularity for powered surfboards. Also, the battery needs to be safely secured to the board when in use.

Electric surfboards are often controlled with a hand control which may be wireless. It is important that the hand control provides a control signal to the correct jet board in order to avoid accidents.

Because the electric surfboards are used in the water, the connectors may corrode despite various efforts to make the connection waterproof.

Moreover, a jet board system comprising a hull and a releasably attached unit such as a battery pack is somewhat heavy and difficult to transport to the beach.

Moreover, it would be desirable if a jet board had a system for easy connection of the fin.

It would also be desirable if an electric surfboard system had internet connectivity in a convenient manner, and if charging of the battery could be carried out remotely.

### SUMMARY OF INVENTION

In a first aspect of the invention a powered surfboard system is provided. The system includes a hull having a forward-rearward axis and a lower side, and a propulsion system having a battery pack and a water jet module. The battery pack and the water jet module are releasably attached to the hull. The battery pack is configured to provide power to the water jet module. The battery pack has a rechargeable battery and a battery pack housing. The lower side of the hull has a recess configured to receive the battery pack and the water jet module such that part of the battery pack housing is at least partly submerged in water when the surfboard is ridden. The battery pack is arranged forward of the water jet module in the recess. The battery pack has a first electrical connector arranged to mate with a second electrical connector arranged on the water jet module. The first electrical connector is arranged on a rearward-protruding part of the battery pack, and the second electrical connector is arranged on a forward-protruding part of the water jet module. The rearward-protruding part of the battery pack is arranged below the forward-protruding part of the water jet module when the hull is oriented as it would be when a user is riding the surfboard in the water.

This provides for a slim design of the board where the hull can have suitable hydrodynamic properties and also convenient assembly of the system.

In various embodiments, an outer surface of the battery pack and an outer surface of the water jet module are configured to form a substantially flush outer surface together with an outer surface of a lower side of the hull.

In various embodiments, the hull has an upper side and the hull as an upper side-lower side axis, and where the connectors are arranged to mate in a mating direction which is essentially parallel to the upper side-lower side axis.

In various embodiments, the connectors comprise a plurality of contact units and where all contact units are arranged in a straight line that is horizontal and perpendicular to the forward-rearward axis of the hull. This provided for a compact and short design of the assembled system.

In various embodiments, the battery pack and the water jet module are reversibly attached to the hull with a fastening mechanism comprising a lever system, the lever system comprising a latching lever that is tiltable in the forward-rearward direction and where the latching lever is configured to be in an latching state where the battery pack and the water jet module are prevented from leaving the recess, and in an open state where the battery pack and the water jet module may be removed from the recess. This provides convenient releasable attachment of the battery pack and the water jet module to the hull.

In various embodiments, the latching state is achieved by moving the lever in the rearward direction and the open state is achieved by moving the lever in the forward direction, where the lever system has a battery moving part arranged to at least partly move the battery pack from the recess when the lever is moved in the forward direction. This assists in overcoming friction forces.

In various embodiments the lever system comprises a motor pressing surface configured to prevent water jet module to move out of the recess when the lever is moved in the forward direction. This also assist in overcoming friction.

In various embodiments the length of the lever is longer than the length of the water jet module in the forward-rearward direction. In a preferred embodiment the lever is attached to the hull. This provides a long lever that provides a lot of torque.

In various embodiments there are two parallel latching levers each arranged to tilt in the forward-rearward direction on each side of the battery pack. This provides convenient handling of the fastening mechanism. In various embodiments the two parallel latching levers are connected by a handle. In various embodiments the handle is arranged to be aft of the water jet module when the levers are in the latching state.

In various embodiments the lever, the battery pack and the hull and the water jet module are arranged such that the lever, when in the latching position, is received in a slot formed by a space between the hull and the battery pack and the hull and the water jet module, said slot being in the forward-rear direction of the hull. This provides suitable hydrodynamic properties. In various embodiments no part of the lever system protrudes below the lower side 14 of the hull when in the latched position.

In various embodiments an outer surface of the battery pack is configured to be in contact with the surrounding water.

In various embodiments the battery pack comprises a metal structure configured to conduct heat from a battery comprised in the battery pack to the surrounding water.

In a second aspect of the invention there is provided a method of assembling a system comprising providing, a hull, a battery pack and a water jet according to the first aspect of the invention, comprising first placing the water jet module in the recess and then placing the battery pack in the recess, such that electrical connectors mates with each other.

In a third aspect of the invention there is provided a powered surfboard system comprising
a hull,
a propulsion system comprising a battery pack and a water jet module,
said battery pack and water jet module being releasably attached to the hull, the battery pack being configured to provide power to the water jet module,
the hull having a forward-rearward axis the hull further having a lower side, the lower side having a recess for receiving the battery pack and the water jet module, where the battery pack has a first electrical connector arranged to mate with a second electrical connector arranged on the water jet module, where the battery pack is arranged in front of the water jet pack in the recess where the first connector is arranged on a rearward protruding part of the battery pack and the second connector is arranged on a forward protruding part of the water jet module and where the rearward protruding part of the battery pack is arranged below the forward protruding part of the water jet module when the hull is oriented as it would be when a user is riding the surfboard in the water.

This provides for a slim design of the board where the hull can have suitable hydrodynamic properties, where the battery can be cooled by the surrounding water and also convenient assembly of the system.

In various embodiments, the outer surface of the battery pack and an outer surface of the water jet module are configured to form a substantially flush outer surface together with the outer surface of the lower side of the hull.

In various embodiments the hull has an upper side and the hull as an upper side-lower side axis, and the connectors are arranged to mate in a mating direction which is essentially parallel to the upper side-lower side axis.

The connectors may comprise a plurality of contact units arranged in a straight line that is horizontal and perpendicular to the forward-rearward axis of the hull. This provided for a compact and short design of the assembled system.

The battery pack and the water jet module may be reversibly attached to the hull with a fastening mechanism comprising a latching lever that is tiltable in the forward-rearward direction and where the latching lever is configured to be in an latching state where the battery pack and the water jet module are prevented from leaving the recess, and in an open state where the battery pack and the water jet module may be removed from the recess. This provides convenient releasable attachment of the battery pack and the water jet module to the hull.

In various embodiments, there are two parallel latching levers each arranged to tilt in the forward-rearward direction between the battery pack and the recess on each side of the battery pack. The two parallel latching levers may be connected by a handle. This provides convenient handling of the fastening mechanism.

An outer surface of the battery pack is configured to be in contact with the surrounding water. In various embodiments, the battery pack comprises a metal structure configured to conduct heat from a battery comprised in the battery pack to the surrounding water. This provides cooling of the battery which extends the life of the battery.

### DRAWINGS

The accompanying drawings form a part of the specification and schematically illustrate preferred embodiments of the invention and serve to illustrate the principles of the invention.

FIG. 1 shows a user riding a jet board, according to some embodiments.

FIG. 2 is a schematic drawing of a system, according to some embodiments.

FIG. 3 is a schematic drawing of a system, according to some embodiments.

FIGS. 4a-c show part of a system, according to some embodiments.

FIGS. 5-6a, 6b and 6c show a system in various stages of assembly, according to some embodiments. In FIG. 5 the battery pack is shown in an exploded view in relation to the hull.

FIG. 6d is a schematic drawing that shows an embodiment of a battery pack, according to some embodiments.

FIGS. 7-9 are schematic drawings that show a system comprising a lever system, according to some embodiments.

FIG. 10a-c show the operation of a lever system, according to some embodiments.

FIGS. 11-12a show details of a system comprising a lever system, according to some embodiments.

FIGS. 12b-c are schematic drawings of a lever system, according to some embodiments.

FIG. 13 is a schematic drawing of electric connectors, according to some embodiments.

FIGS. 14-16 show an embodiment of electric connectors, according to some embodiments.

FIG. 17 is a schematic drawing of an embodiment of electric connectors, according to some embodiments.

FIGS. 18a, 18b and 19 are schematic drawings of a system comprising an identification tag, according to some embodiments.

FIG. 20 is a schematic drawing of a control device, according to some embodiments.

FIG. 21 is a schematic drawing of an input device, according to some embodiments.

FIGS. 22a, 22b and 23 are flowcharts showing methods, according to some embodiments.

FIGS. 24-26 shows a carrying system, according to some embodiments.

FIGS. 27-28 are schematic drawings of a system comprising a fin, according to some embodiments.

FIGS. 29-30 shows details of a system comprising a fin, according to some embodiments.

FIG. 31a-c are schematic drawings of a system comprising a fin, according to some embodiments.

FIGS. 32-33 are schematic drawings of systems, according to some embodiments.

### DETAILED DESCRIPTION

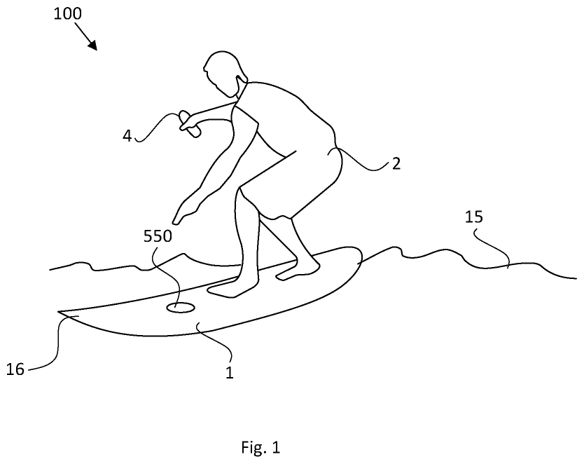

With reference to FIGS. 1-6, water sports system 100 comprises a hull 1 which may be arranged to float on the water. The hull 1 may comprise at least some buoyancy for a user 2. In some embodiments the hull 1 is arranged to provide full buoyancy to a user 2. However, when user 2 rides the hull 1, the hull 1 provides buoyancy to the user 2. It is to be noted that when hull 1 is not moving through the water hull 1 may not necessarily provide full buoyancy to a user 2.

In a preferred embodiment, water sports system 100 may be a so-called jet board or a powered surfboard and may be referred to as such below, however, the disclosure is not limited to a jet board or a powered surfboard as such. In other embodiments the water sports system 100 may be a water scooter or PWC (personal watercraft), or an underwater personal craft. However, in the following, the water sports system 100 will be described in relation to a jet board/powered surfboard.

The hull 1 has an upper side 5 which preferably is arranged to support a standing user 2, in particular when riding. The upper side 5 may have an anti-slip surface. The user may also be referred to as a “rider” herein. The hull 1 is arranged to mainly support a standing user 2. Hence the hull 1 of a jet board lacks a seat or a saddle.

The hull 1 may be in the form of a board. The hull 1 is preferably elongated and has a front end 16 (bow) and a rear end (stern/aft) 17 and hence hull 1 has a front end-rear end axis. The hull 1 has a lower side 14 which may be arranged to interact with the surrounding water during propulsion and may hence have suitable hydrodynamic characteristics, including channels and/or one or more fins 400 to provide low resistance and stability in the water. The system 100 preferably has a fin 400 for providing directional stability. The fin 400 may, in some embodiments, be arranged on the water jet module 10 or on the hull 1.

The hull 1 may have an upper side-lower side axis that is perpendicular to the forward-rearward axis of the board.

The hull 1 may comprise an inner core of for example foam or may be hollow. The hull 1 may have an outer layer of for example ABS plastic, laminated glass fiber, carbon fiber or the like. The front end 16 of the hull 1 may comprise a shock absorber made of a suitable elastomeric material such as, for example, rubber. The shock absorber may be arranged to protect the hull 1 from damage in case of collision and also to soften any impact for the user 2.

The system 100 preferably comprises a propulsion system 3 arranged to provide propulsion to the hull 1 through water. The system 100 comprises a hand-held input device 4 which a user 2 may use to control the speed. The hull 1 is arranged to travel mainly with the front end 16 pointing in the direction of movement. The propulsion system 3 may be substantially or completely submerged during operation.

The hull 1 of a jet board may optionally have a submerged wing or hydrofoil for foiling. The wing or hydrofoil may be releasably attached to the hull 1. The hydrofoil may be arranged to lift the entire hull 1 or a substantial part of the hull 1 out of the water during riding/operation.

Propulsion system 3 comprises battery pack 6 and water jet 7. Battery pack 6 is arranged to provide power to the water jet 7. Battery pack 6 may be releasably attached to the hull 1. Battery pack 6 may be releasably attached to the hull 1 using a fastening mechanism, which may be a latching system.

Water jet 7 comprises a motor, which preferably is an electric motor, a shaft and an impeller arranged in a jet channel. The jet channel has a water intake and an opening or nozzle 21 towards the rear 17 of the hull 1. The water jet 7 may be provided as a separate water jet module 10 comprising a housing 11 that is releasably attached to the hull 1. Water jet module 10 may be releasably attached to the hull 1 using a fastening mechanism, which may be a latching system. However, in some embodiments, the water jet 7 is more permanently integrated into the hull 1.

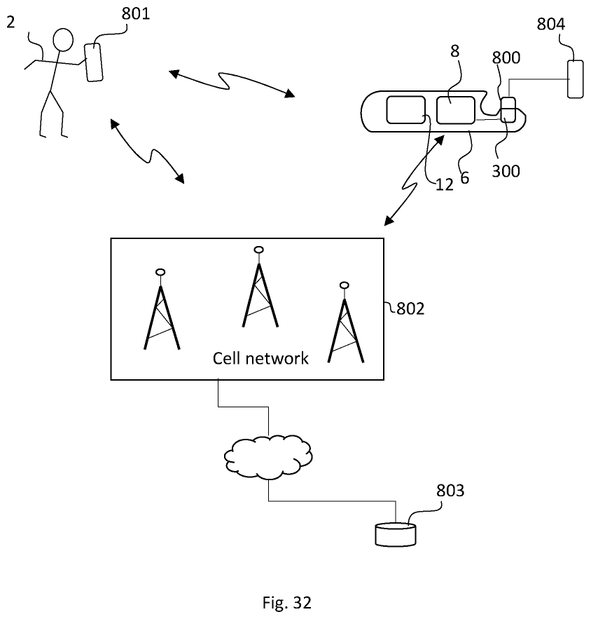

Battery pack 6 comprises a rechargeable battery 8 and battery pack housing 9. Battery 8 may comprise a number of separate cells as is known in the art. Battery pack housing 9 may for example have the approximate shape of a flattened rectangle. When a battery 8 has run out of power, a user may conveniently swap or replace a first battery pack 6 which has been depleted with a second battery pack 6 with a freshly charged battery 8. The battery pack 6 or the water jet module 10 may be moved to a different hull 1, for example if a user has two different hulls 1 that can be used alternating with the same battery pack 6 or same water jet module 10. The battery 8 may be charged as is known in the art. In various embodiments, the battery 8 is connectable to a charger 800 which is connectable to a power source 804 (FIG. 32). In a preferred embodiment the battery pack 6 is connectable to a charger 800.

The hull 1, the battery pack 6 and the water jet module 10 is waterproof or watertight as required, in particular for avoiding that water comes into contact with parts that are sensitive to water such as electric connectors and electronics. Each of battery pack 6 or water jet module 10 may comprise a handle 23 for carrying the battery pack 6 or the water jet module 10, respectively. A part of the water jet inlet may serve as a handle for the water jet module 10.

The battery pack 6 may be configured to mechanically or electrically connect to the hull 1 or the water jet module 10, or both. When the battery pack 6 is mechanically connected to the hull 1, an electrical connection is formed with the water jet 7, in order to power the water jet 7. The water jet module 10 may be configured to mechanically or electrically connect to the battery pack 6 or the hull 1, or both. The connections may be releasable. The battery pack housing 9 and the housing 11 for the water jet module 10 may abut (touch) each other when connected to the hull 1.

The hull 1 may have a recess 13 or basin configured for receiving the battery pack 6. The recess 13 may be described as a recessed compartment. The recess 13 may be arranged on the upper side 5 of the hull 1 or on lower side 14 of the hull. An advantage with providing the recess 13 for the battery pack 6 on the lower side 14 of the hull 1 is that a part of the housing 9 of the battery pack 6 will be at least partly submerged in the water when riding, which will provide cooling to the battery 8. This extends the battery life. The housing 9 of the battery pack 6 may comprise a metal structure 20, such as a metal plate, arranged to conduct heat from the battery 8 to the surrounding water. The structure 20, such as the metal plate may, be arranged between the battery 8 and the inner lower surface of the battery pack housing 9. The metal plate may be arranged approximately parallel to the lower surface of the hull 1. Suitable metals include, for example, copper, steel and aluminum.

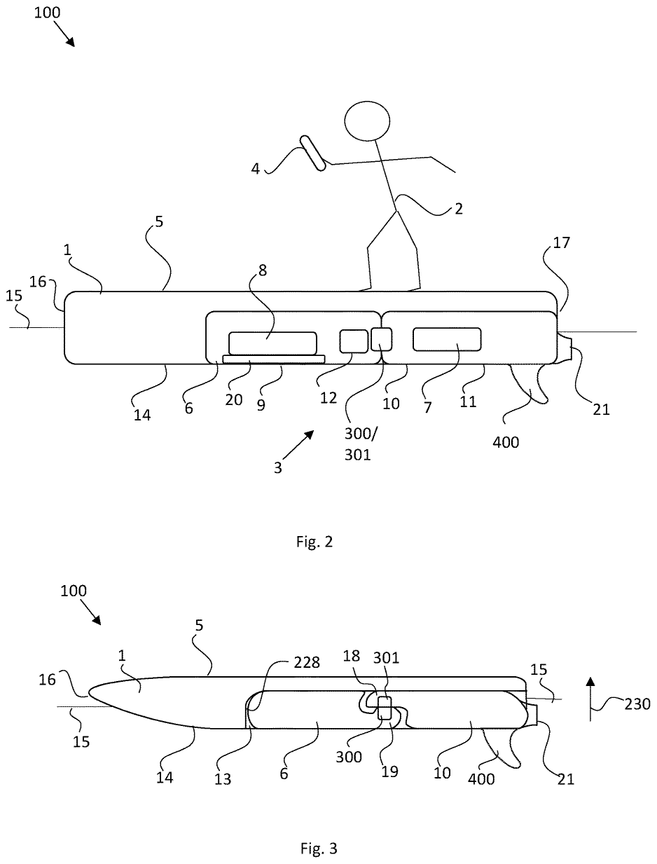

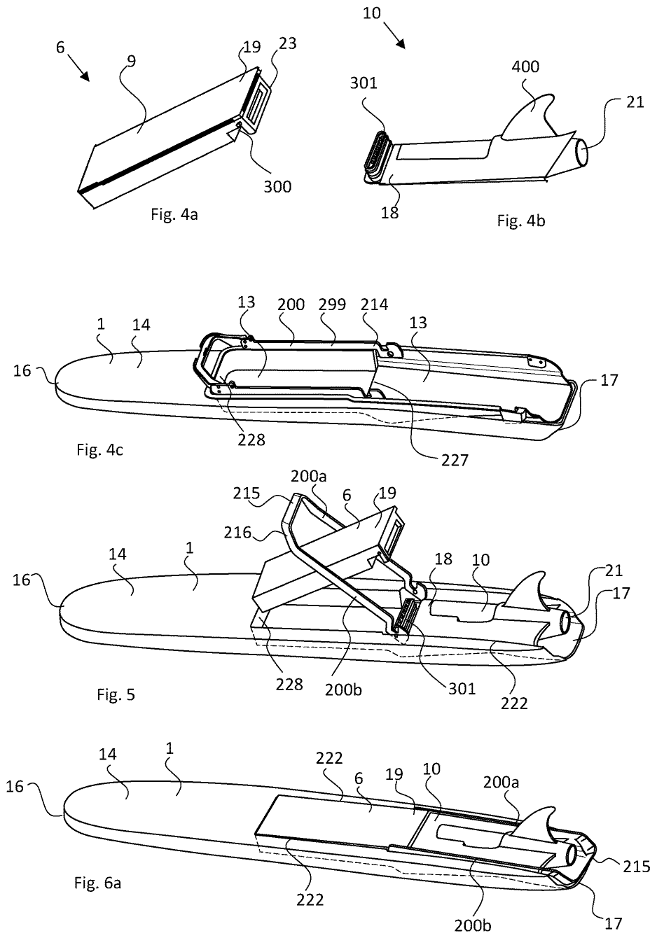

It is to be noted that term such as “upper”, “lower” “underside” et cetera is be understood in relation to how a user 2 would normally interact with the various parts of the system 100, hence in relation to a jet board that is floating in the water 15 as seen in FIGS. 1 and 2 and where a user 2 is standing on the upper side 5. Exchange of a battery pack 6 may conveniently take place with lower side 14 of hull 1 upwards, for example when the hull 1 is lying on the shore, and therefore FIGS. 4-12 show hull 1 with its lower side 14 upwards in the figures. The battery pack 6 may then be lowered into a recess 13. “right” and “left” refers to directions that a user 2 riding the board and looking forward would use the terms.

When discussing the fastening mechanism including lever 200 for locking the battery pack 6 it will be described in relation to recess 13 into which a battery pack 6 is lowered, wheatear or not the recess 13 is arranged on the upper (standing) surface of the hull 1 or the bottom surface of the hull 1.

The recess 13 may be configured to receive the battery pack 6 or the water jet module 10, or in a preferred embodiment, both, in particular when the recess 13 is arranged on the underside 14 of the hull 1. As noted herein, in various embodiments a “recess” on the underside of the hull 1 extends into the body of the hull 1 from the lower side 14 and may hence be open towards the ambient water. The battery pack 6 or water jet module 10 may be configured to be retained in the recess 13 when the user 2 is riding the powered surfboard.

When the recess 13 is on the lower side 14 of the hull, it may be configured to receive the water jet module 10 and the battery pack 6. Preferably the battery pack 6 is located adjacent to the water jet module 10, preferably abutting the water jet module 10. The battery pack 6 is preferably in front of the water jet module 10 Hence, the battery pack 6, when received by the recess 13, is arranged in front of the water jet module 10.

The water jet module 10 and the battery pack 6 may, in some embodiments, have approximately the same thickness. In other embodiments, the water jet module 10 and the battery pack does not have the same thickness. The recess 13 and the lower side of the battery pack 6 and the water jet module 10 may then be adapted to provide an essentially level and smooth surface in particular where the battery pack 6 abuts the water jet module 10.

The recess 13 may be arranged to snugly receive the battery pack 6 or the water jet module 10 or both. The battery pack 6 may abut a side of the recess 13. In particular the front end of the battery pack 6 may abut the forward wall 228 of the recess 13. Front end of water jet module 10 may be configured to abut an internal edge 227 of recess 13 (FIGS. 3, 9 and 10a).

The battery pack 6 may have approximately the same width (along the length (forward-rearward) of the of the battery pack 6. The water jet module 10 may have approximately the same width along the length of the water jet module 10. The water jet module 10 and the battery pack 6 may have the same width (right-left direction).

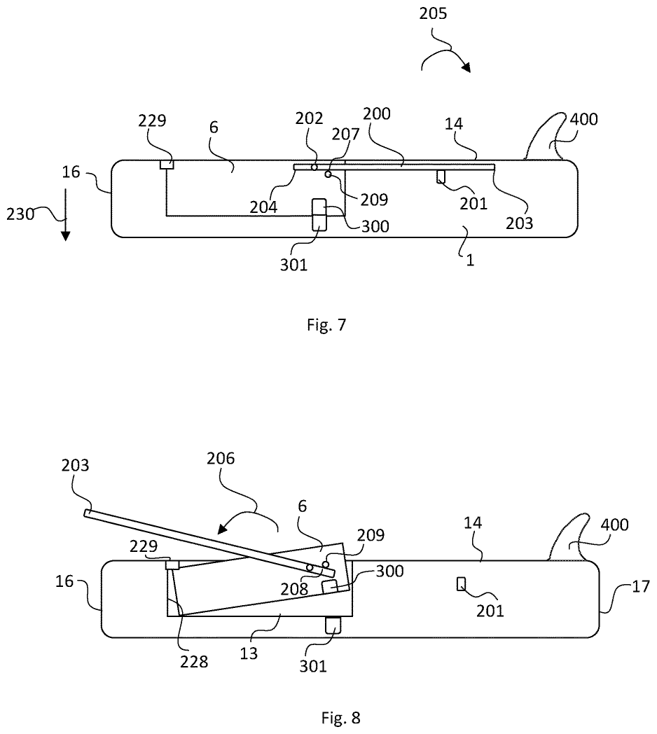

Battery pack retention member 229 (FIG. 7) is a part of hull 1 that restricts the movement of battery pack 6 from recess 13 and which may be localized in the forward end of recess 13. Battery pack 6 may be inserted with its forward end first below battery pack retention member 229 and then lowered in to recess 13. The lever 200 may then be put in the latching state (see below) so that the rear end of the battery pack 6 is kept in place by the lever 200 and the forward end of the battery pack 6 is kept in place by battery pack retention member 229. Battery pack retention member 229 may be shaped as a lip along the forward edge of the recess 13.

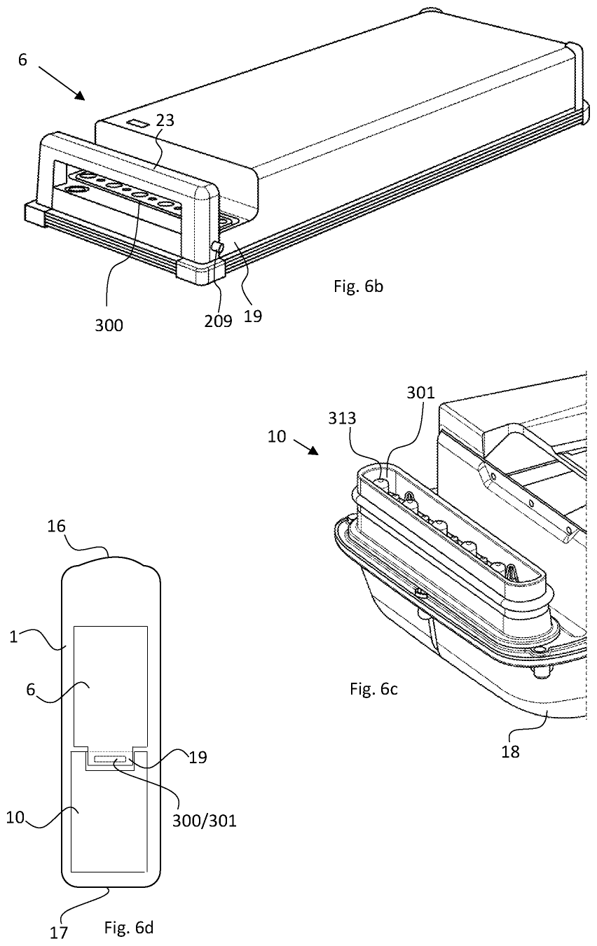

Returning to FIG. 1-6, the battery pack 6 or the water jet module 10 preferably has an outer surface that forms a flush surface together with the outer side of the hull 1, in particular when the recess 13 for receiving the battery pack 6 or the water jet module 10 is arranged in the lower side 14 of the hull. An example is shown in FIG. 6a. When the hull 1 is assembled with the battery pack 6 and optionally the water jet module 10, the underside of the hull 1 and the underside of the battery pack 6 and the water jet module 10 may form a substantially flush, smooth or even surface. The flush, smooth or even surface provides low resistance in the water.

When the hull 1 has a wing or hydrofoil, the water jet module 10 may be integrated with the hydrofoil. The water jet pack 10 may be arranged as a part of the hydrofoil or in the hydrofoil. A battery pack 6 being releasably attached to the hull 1 may then provide power to the water jet 7 trough one or more struts for the hydrofoil.

The system 100 is conveniently assembled by inserting a battery pack 6 into recess 13, and optionally inserting water jet module 10 into recess 13. The system 100 can conveniently be disassembled.

The system 100 comprises a control device 12. The control device 12 is arranged as a part of the propulsion system 3. The control device 12 may be arranged in battery pack 6 or distributed between battery pack 6 and water jet 7 or between battery pack 6 and water jet module 10. In a preferred embodiment the control device 12 is arranged in the battery pack 6. Hence, the control device 12 comprises a memory 50 and hence the memory 50 may be arranged in a housing that is releasably attached to the hull 1.

A user 2 may control propulsion by providing input to an input device 4 which in turns provides a control signal to the control device 12. The control device 12 controls the current provided from the battery 8 to the motor of the water jet 7. Input device 4 may be a handheld input device 4. Input device 4 may provide the control signal to the control device 12 using a wire or via a wireless connection, as described in more detail below.

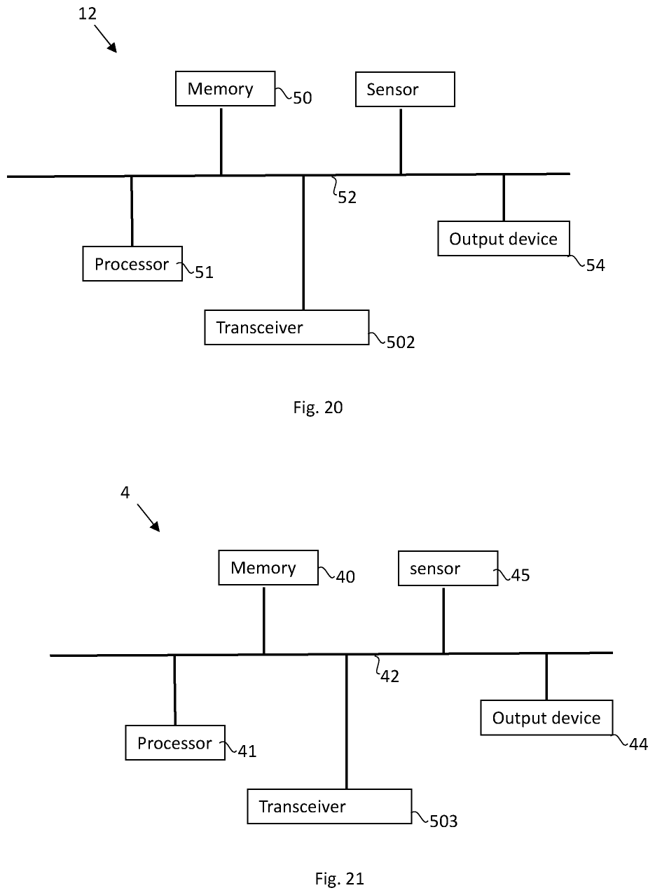

With reference to FIGS. 20-21, the control device 12 may comprise a memory 50, a processor 51 and a bus 52, a transceiver 502 and output device 54 for controlling the motor. The control device 12 may comprise control circuitry. The control device 12 is powered by battery 8.

The input device 4 may comprise a memory 40, a processor 41, a bus 42 a transceiver 503, output device 44 and sensor 45. The handheld input device 4 may be powered by a battery, for example a rechargeable battery.

Sensor data may be provided from sensors to the control device 12. The sensor may be for example humidity sensors, temperature sensors for the motor, pressure sensor for leak testing. A sensor may be present in, for example water jet module 10 or battery pack 6.

Returning to FIGS. 2-6 in particular FIGS. 2-3, the battery pack 6 has a first electrical connector 300 arranged to mate with a second electrical connector 301 in the hull 1 or preferably in the water jet module 10 so that the battery 8 can provide power to the water jet 7. In addition, the electrical connector may provide a separate circuit that provides data exchange between the battery pack 6 and the water jet 7 or between battery pack 6 and charger 800. Hence the first and second connector 300,301 may have 2, 3, 4, 5, 6, 7, 8 or more contacts units 317 (see below). The first or second connector 300, 301 may be provided with at least one gasket or O-ring to prevent water to reach the electrical parts of the connector. One or more of contact units 317 may be dedicated for charging the battery 8.

The first connector 300 is arranged to mate with the second connector 301 in the mating direction 230. When the second connector 301 is arranged on the water jet module 10 the second connector 301 may be arranged on the water jet module 10 such that second connector 301 is located in the recess 13 when the water jet module 10 is placed in the recess 13. The mating direction 230 may be parallel to the upper side-lower side axis of the hull, or diverting from that axis at most 15 degrees, more preferably at most 5 degrees.

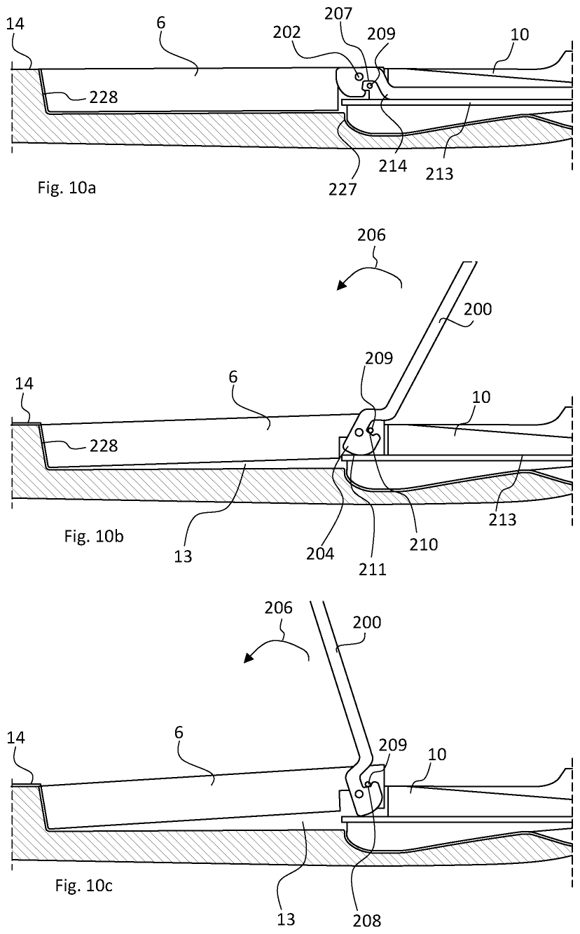

The battery pack 6 may be removable from hull 1 by translating it away from the recess 13, in a direction that is opposite the mating direction 230. It should be noted that with reference to FIGS. 8 and 10a-10c that movement away from recess 13 may involve rotation of the battery pack 6, around a point of contact between the battery pack 6 and hull 1, for example retention member 229.

The first electrical connector 300 may be arranged to mate with the second electrical connector 301 when the battery pack 6 is inserted into the recess 13. The battery pack 6 may be insertable into the recess 13 in order to make the first electrical connector 300 mate with the second electrical connector 301 in mating direction 230. The second electrical connector 301 may be arranged in the recess 13 of the hull 1 or, preferably, on the water jet module 10. The housing 9 of the battery pack 6 is preferably guided by its snug fit to the recess 13 so that connectors 300 and 301 are aligned. A snug fit between the water jet module 10 and recess 13 ensures that second connector 301 is properly positioned to receive the first connector 300.

With reference to FIG. 3 and FIGS. 4-6a when the water jet 7 is arranged in water jet module 10, the water jet module 10 is preferably arranged rearward of the battery pack 6 in recess 13. When the recess 13 is arranged on the bottom side 14 of hull, water jet module 10 may have a forward protruding part 18 comprising the connector 301 being arranged above a backwards protruding part 19 of the battery pack 6 on which the first connector 300 is arranged. Here, “above” refers to when the hull is floating in the water as seen in FIGS. 1-3. When the hull 1 is placed with the recess 13 upwards (for example on the beach), the backwards protruding part 19 of the battery pack 6 will be above the forward protruding part 18 of the water jet module 10. Hence, when riding, the forward protruding 18 part will be arranged above the rearward protruding part 19 of the battery pack 6. Battery 8 in battery pack 6 may be wholly or partly located in front of water jet module 10.

It is preferred that battery 8 is not comprised in backwards protruding part 19. Backwards protruding part 19 essentially serves to carry first connector 300. In a similar fashion, forward protruding part 18 of water jet module 10 serves to carry the second connector 301. Hence there is an overlap between the forward protruding part 18 and the backwards protruding part 19. The overlap may have a length of about 25 mm to 200 mm in the forward-rearward direction, more preferably from 60 mm to 150 mm.

Carrying handle 23 for battery pack 6 may be arranged on backward protruding part 19.

The contact units 317 (see below) are preferably arranged in a narrow zone of the overlap in the forward rear axis. The centers of the contact units 317 are preferably arranged along a straight line that is horizontal and perpendicular to the forward reward axis of the hull 1 as seen in the figures. A linear arrangement of the contact units 317 makes it possible to provide a better location of the battery pack 6 in the hull 1. The hull 1 can be made shorter, which makes it more agile in the water. A more or less linear arrangement of the contact units 317 makes it easier to connect the contact units to a circuit board in the battery pack 6. The contact units 317 may however, be slightly spread in the forward-rearward direction. Preferably the centers of the contact units 317are located in a zone that is no more than 50 mm, preferably no more than 20 mm long in the forward rearward direction of the hull. 3.

The overlap may be arranged in any suitable manner. In some embodiments the overlap is arranged along the entire width of the battery pack 6 and the water jet module 10 as seen in the FIGS. 4, 5 and 6a, 6b and 6c. In some embodiments, however, the overlap is along a part of the width of the battery pack 6 or water jet module 10. For example, the middle part of the battery pack 6 may have a backwards protruding part 19 in the form of tail that overlaps a section of the width of the water jet module 10 and where the first connector 300 is arranged on the tail as seen in FIG. 6d. The tail may be arranged to mate with a bay on water jet housing 10. In a corresponding manner, the water jet forward protruding part 18 of the water jet module 10 may be the form of a lip along a part of the width of the water jet module 10.

In some embodiments, two or more electric motors drive one impeller. The impeller may be arranged on a main shaft and at least two electric motors are arranged to simultaneously drive the main shaft to turn the impeller, wherein the electric motors drive the main shaft using a transmission means. For example, the two motors each drive a first and a second gear wheel which both are connected to a drive gear wheel that drives a drive shaft that in turn drives the impeller. Each of the motors comprises motor shafts and both the motor shafts may be parallel to the main shaft and offset from the main shaft and from each other. The gear wheel may be placed in front or back of the motors.

The electric motor may be a brushless three-phase motor. The phases of the electromagnets may be controlled by software, provided in control device 12, which software may comprise a mathematical model of the motor and where a digital control signal is provided from the control device 12 to control the output from the battery 8 to control the motor.

An advantage with providing the water jet 7 in a water jet module 10 is that the water jet module 10 can be used in more than one hull 1. A user can conveniently move the water jet module 10 from a first hull 1 to a second hull 1. Moreover, service of the water jet 7 is facilitated. The system 100 is also easier to transport.

There is also provided a method of assembling a system comprising assembling the hull 1, with the battery pack 6 and optionally the water jet module 10. The method may comprise the step of first inserting the water jet module 10 into the recess 13 and then inserting the battery pack 6 so that connectors 300, 301 are connected. The battery pack 6 may be inserted into the recess 13 with the forward end first.

### Lever

With reference to FIGS. 7 to 12 and also 4a-6a, the system 100 preferably comprises a fastening mechanism for releasable fastening the battery pack 6 and/or the water jet module 10 to the hull 1. The mechanism may be a latching mechanism. FIGS. 7 and 8 shows a hull 1 with its lower side 14 upwards as a user would place the hull 1 when attaching or detaching the battery pack 6 to the hull 1 when the recess 13 is on the lower side 14 of the hull 1. In some embodiments, the lever 200 may be placed on the upper side 5 of the hull 1, for example when the battery pack 6 is received in a recess 13 on the upper side 5 of the hull 1.

The fastening mechanism may comprise a lever system 299 comprising a lever 200. The lever 200 provides torque for a user 2 that operates the fastening mechanism. The lever system 299 is preferably attached to the hull 1.

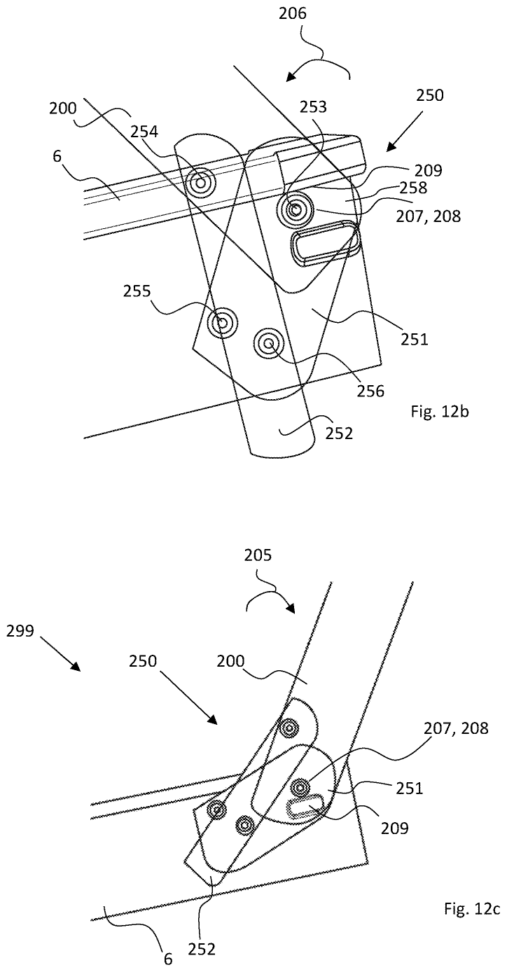

The fastening mechanism may comprise a latching lever 200, which may be attached to the hull 1 at a pivot point 202 between a first end 203 and a second end 204 of the latching lever 200. However, as seen in FIGS. 12b and 12c the latching lever 200 does not need to be directly attached to the hull 1 but may for example be attached to the hull via one or more other members such as linking parts 251, 252. In some embodiments the latching lever 200 may be attached to the battery pack 6 or the water jet module 10.

The lever 200 is tiltable in a first in a first direction 205 and a second direction 206 which is opposite to the first direction 205. The lever 200 may be rotably tiltable. The lever 200 is provided for latching and releasing the battery pack 6. The latching state is achieved by moving the lever 200 in the first direction 205, optionally until an end position for lever 200. The open state is achieved by moving the lever 200 in the second direction 206, optionally to an end position. Hence the lever 200 may be in a latching state where the battery pack 6 (or the water jet pack 10 or both) is prevented from leaving the recess 13 and open state where the battery pack 6 (or the water jet pack 10 or both) can be removed from the recess 13. Hence the battery pack 6, and optionally the water jet module 10 is held in place in the recess 13 when the lever 200 is in the latching state.

The lever 200 may have a hand-operated locking mechanism 201 that holds the lever 200 in the latching state. The locking mechanism 201 may for example comprise a spring that biases a locking element of the lever 200 into a locking recess of the hull 1, and where the spring can be counteracted by the user 2 pressing a button.

Lever 200 may be made in any suitable material such as metal or carbon fiber. The lever 200 may comprise a truss structure in particular when the lever 200 comprises carbon fiber.

The lever 200 may have a battery locking element 207. The battery locking element 207 preferably at least restricts the movement of the battery pack 6 in a direction that is opposite to the mating direction 230 mentioned above when the lever 200 is in the latching position, thereby keeping the battery pack 6 attached to the hull 1. The battery locking element 207 may be arranged between a first end 203 and the pivot point 202 of the lever 200

The battery locking element 207 may be arranged to press the battery pack 6 into the recess 13 when the lever 200 is tilted in the first direction 205. This overcomes friction forces of the connectors 300 and 301. In some embodiments the battery locking element 207 prevents removal of the battery pack 6 when the lever 200 is in the latching state.

The lever 200 is preferably arranged to pivot in the forward-aft direction of the hull 1. The length of the lever 200 is preferably at least 50 cm more preferably at least 75 cm and most preferably at least 100 cm. The maximum length may be adapted to the hull 1 but a suitable maximum length may be about 150 cm. The length of the lever 200 may be defined as the longest part from its attachment point or pivot point to and end point, which typically is first end 203 of the lever 200. When there are two levers 200a 200b they are preferably of the same length. A long lever 200 provides sufficient power to lock and unlock battery pack 6 and/or water jet pack 10. The length of the lever 200 may be adapted so that the locking mechanism 201 is located at the rear end 17 of the hull 1, as seen in FIG. 6a. This prevents water from interacting with the locking mechanism 201, in particular streaming water.

It is preferred that the first direction 205 is towards the back end 17 of the hull 1 (rear direction) and that the second direction 206 is in the direction towards the front end 16 of the hull 1 (forward direction), in particular when the recess 13 for the battery pack 6 is arranged forward of the water jet 7. This makes it easier to accommodate the lever in the hull when the lever 200 is in the latched position. However, in various embodiments, the first direction 205 is towards the front end 16.

The lever 200 may have a latching position where the lever 200 is essentially parallel to the forward-aft axis of the hull 1, or diverting from that axis at most 15 degrees, more preferably at most 5 degrees, see FIGS. 6, 7 and 10a.

As mentioned above, the battery pack 6 may be releasably attachable to the hull 1 by moving the battery pack 6 in a mating direction 230 into the recess 13, said mating direction 230 being a direction that makes the first electrical connector 300 of the battery pack 6 mate with the second electrical connector 301 in the hull 1 or in a water jet module 10.

The battery locking element 207 of the lever 200 may be arranged to press the battery pack 6 in the mating direction 230 when the lever is moved in the first direction 205. This makes the contact units 317 of the first and second electrical connectors 300, 301 come in contact with each other to provide power to the water jet 7, because the electrical connectors 300, 301 may comprise a number of contact units 317 and a certain force may be required to overcome the friction of the connector units and gaskets and any springs in the connectors 300, 301.

The lever system, for example latching lever 200, in particular the second end 204 of the lever 200, may have a battery moving part 208 arranged to remove the battery pack 6 from the recess 13 when the lever 200 is moved in the second direction 206. An example of this can be seen in FIGS. 7-8 and also 9-12. The battery moving part 208 may cause first connector 300 to move away and disconnect from second connector 301. Hence when a user moves the lever 200 in the second direction 206 the battery moving part 208 may lift the battery from recess 13 and separate first and second connectors 300, 301. The battery pack 6 may tilt during this operation. The contact elements and in particular any gasket or O-ring may generate considerable suction forces and the lever 200 helps in overcoming these forces when removing the battery pack 6. Battery moving part 208 may be the same as battery locking element 207 (See FIGS. 12b and 12c).

The battery pack 6 may have a cooperating element 209. The cooperating element 209 is arranged to interact with the lever system 299, in particular the battery locking element 207 or the battery moving part 208, or both. The cooperating element 209 may be a part of the battery pack housing 9. The cooperating element 209 may be arranged on a vertical side surface of the battery pack, where the side surface is substantially parallel to the forward-rear axis of the hull 1. The battery pack 6 may have one cooperating element 209 on each side of the battery pack (right/left). The cooperating element 209 may protrude from the main body of the battery pack 6 in an axis that is parallel to the axis of rotation of the lever 200. The cooperating element 209 may for example protrude from the battery pack 6 or may be a groove in the battery pack 6. When the cooperating element 209 is a groove, the battery moving part 208 may be arranged to fit in the groove and to move along the groove when lifting the battery pack 6.

The pivot point 202 may be arranged above the cooperating element 209 when the battery pack 6 is in the latched position, as shown in FIG. 7. The cooperating element 209 may travel in a position from below the pivot point 202 to a position above the pivot point 202 when the lever 200 is moved in the second direction 206 (to remove the battery pack 6) as seen in FIGS. 7-8. The pivot point 202 may be attached to the hull 1 so that it is arranged forward of the cooperating element 209 when the battery pack 6 is has been inserted into the recess 13.

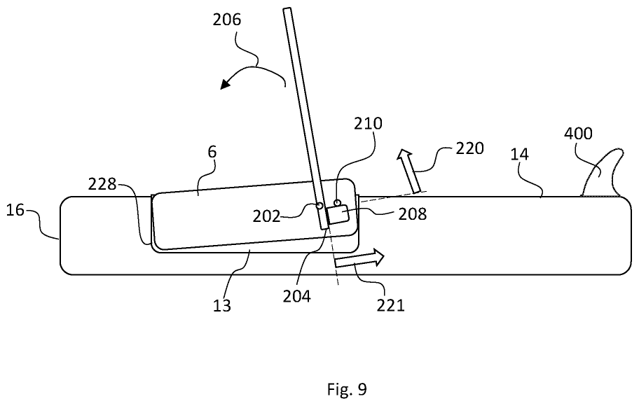

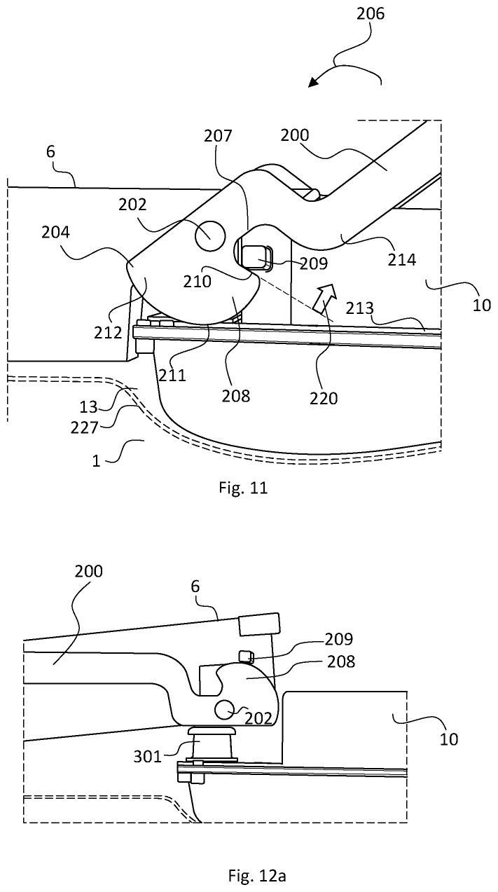

With reference to FIGS. 9-12, the battery moving part 208 may comprise a radial extension surface 210, said surface being parallel to the axis of rotation of the lever 200 and being arranged to radially travel before the second end 204 of the lever 200 when the lever 200 is moved in the second direction 206 to at least partly remove the battery pack 6 from recess 13. Radial extension surface 210 may interact with cooperating element 209 in order to move battery pack 6 from recess 13 as best seen in FIG. 11. This makes it possible to at least partly remove the battery pack 6 further from the recess 13. The pivot point 202 defines the axis of rotation of the lever 200. Arrows 220 and 221 indicate that radial extension surface 210 radially travels before the second end 204 of the lever 200 when the lever 200 is moved in the second direction 206.

In general, with reference to FIGS. 7-12, when the propulsion system 3 comprises a releasably attachable water jet module 10 the lever 200 may be arranged to latch the water jet module 10 to the hull 1. This provides simultaneous latching and releasing of the battery pack 6 and the water jet module 10 in a convenient manner. The recess 13 is then preferably arranged on the bottom side 14 of the hull 1 and is arranged to receive the water jet module 10 and the battery pack 6. The battery pack 6 is preferably arranged in front of the water jet module 10 in the recess 13.

The water jet module 10, in particular the housing 11 of the water jet module 10 may have a protruding edge 213 and the lever 200 may latch the water jet module 10 by abutting the protruding edge 213. The protruding edge 213 may interact with a part of the lever 200, for example a part of lever 200 between the pivot point and the first end 203 of lever 200. The protruding edge 213 may interact with lever 200 when the lever 200 is in the latched position. The lever 200 may then be in physical contact with protruding edge 213. The lever 200 may thereby limit the movement of the water jet module 10. Hence the protruding edge 213 may be below the lever 200 in the latching position. Protruding edge 213 may extend in the right/left direction from the water jet housing 11 and facing upwards towards the lever 200 when the hull 1 is placed with the lower side 14 facing upwards. The protruding edge 213 may be arranged parallel to the main direction of the lever 200, preferably in the forward-aft direction of hull 1. The right or left side or both of water jet module 10 may have protruding edges 213. In a preferred embodiment both right and left sides of water jet pack 10 has protruding edges 213 and each protruding edge 213 is held in place by one latching lever 200a, 200b

Water jet module 10 may have its own sub-recess as a part of recess 13. The front end of the water jet housing 11 may abut the internal edge 227 of the recess 13. This prevents the water jet pack 10 from moving forward when moving the lever 200 forward. Internal edge 227 is preferably facing rearwards in particular when water jet module 10 is slimmer than the battery pack 6.

As most clearly seen in FIGS. 10 to 12, a part of lever system 299, for example second end 204 of the lever 200 may have a motor pressing surface 211 arranged to press against the water jet module 10, for example the protruding edge 213, or against the hull 1, for example the bottom of the recess 13, when the lever 200 is moved in the second direction 206. This further assists in separating the electrical connectors 300, 301. The motor pressing surface 211 may press the water jet module 10 generally in the mating direction 230. The motor pressing surface 211 may be arranged on a radial extension 212 on of the second end 204 of the lever 200. The radial extension 212 may be fin-like. The motor pressing surface 211 may be arranged to travel on protruding edge 213 or against the surface of recess 13 as the lever 200 is moved in the second direction 206. In general, the motor pressing surface 211 prevents water jet module 10 to move out of the recess 13 together with the battery pack 6 when the lever is moved in the second direction 206. This prevents movement of the water jet module 10 in manner that may damage connectors 300, 301.

In various embodiments, the motor pressing surface 211 may be arranged on a on a radial extension 212 of the lever 200 or on a non-hull member that participates in the four-bar linkage 250 (see below).

In a preferred embodiment the lever 200 pivots in the front-rear direction of the hull 1, and the system 100 comprises a water jet module 10 being releasable attachable to the hull and arranged rear of the battery pack 6 in relation to the hull 1. The motor pressing surface 211 may then be configured to press down on the water jet module 10 when the lever is moved in the second direction 206 and the second direction 206 is toward the front 16 of the hull 1. This has the advantage of providing a long lever that overcomes suction forces.

The motor pressing surface 211 may be arranged to, in addition, travel along the cooperating element 209 of the battery pack 6 as the lever 200 is moved in the second direction 206 as best seen in FIG. 12a. The cooperating element 209 may then rest on motor pressing surface 211 and motor pressing surface 211 is then preferably arranged as the normal to the pivot point 202 as seen in FIG. 12a. This prevents the lever 200 from catapulting if the user accidentally drops the battery pack 6.

One embodiment of lever system is shown in FIGS. 12b and 12c. Here lever 200 is attached to the hull 1 with a four-bar linkage 250. The four-bar linkage 250 makes the lever 200 tiltable. The four-bar linkage makes it possible to pivot the lever 200 in the first and second directions 205, 206. The four-bar linkage 250 may have any suitable design, and there are many different ways of arranging a four-bar linkage. This may have the advantage that the lever can be moved a full 180° or almost a full 180° in the forward-rear axis of the hull 1. I may also provide gearing so that battery pack 6 is lifted without having to move the lever 200 a long distance. Furthermore, it makes it possible to tilt the lever 200 so that it disappears into the recess 13 preferably in a slot between the battery pack 6 and the hull 1 or between the water jet module 10 and the hull 1.

The four-bar linkage 250 of FIGS. 12b and 12c comprises two members, a first linking part 251 and a second linking part 252 that are each attached to the lever 200 and to the hull 1, whereas the lever 200 is not directly attached to the hull 1. The first linking part 251, second linking part 252 and lever 200 are able to rotate around their attachment points to a certain extent. Hence, in various embodiments, the four-bar linkage 250 comprises two members attached to the hull 1 and to the lever 200.

Four-bar linkage 250 may be formed by lever 200 which is rotably attached to first linking part 251 at a first pivot point 253 and second linking part 252 which is notably attached to lever 200 at second pivot point 254. First linking part 251 is rotatable attached to hull 1 at third pivot point 255. Second linking part 252 is rotably attached to hull 1 at fourth pivot point 256. The third and fourth pivot 255, 256 may be fixed pivot points. The four-bar linkage 250 may be such that none of the participating parts can make a full revolution. The pivot points can be arranged in any suitable manner. The parts 200, 251, 252 are arranged to rotate along the plane of the movement of the lever 200, indicated with arrows 205 and 206. The second linking part 252 may be arranged forward of the first linking part 251.

Battery locking element 207 may be arranged in any suitable manner in lever system 299, for example the lever 200, or on first and second linking parts 251, 252. For example, battery locking element 207 may be arranged on first or second linking parts 251, 252.

Battery moving part 208 may be arranged in any suitable manner in lever system 299, for example on the lever 200, or on first or second linking parts 251, 252 preferably on first linking part 251.

In FIGS. 12b-12c battery locking element 207 and battery moving part 208 is configured as a wheel that protrudes from first linking part 251 and that interacts with cooperating element 209 in a rolling manner. In FIGS. 12b and 12c cooperating element 209 comprises two protruding parts that form a slot 258 where the wheel fits. When the wheel presses upwards in the slot the battery pack 6 is lifted. When the wheel presses downwards the battery pack 6 is pressed down in the recess 13. Battery locking element 207/battery moving part 208 may off course have any suitable shape such as knob.

Motor pressing surface 211 may be arranged on first linking part 251 or second linking part 252.

The lever system 299 in particular latching lever 200 may be arranged to fit in a slot 222 in the hull 1 in the latching position. The slot 222 is preferably extends in the forward-rearward direction to receive lever 200. The slot 222 may be a part of recess 13. The slot 222 may be formed as a space between the battery pack 6 and the hull 1 and optionally between water jet module 10 and hull 1. The lever system 299 in particular latching lever 200 may disappear completely into slot 222 in the latching position. Preferably no part of the lever system 299 protrudes below the lower side 14 of the hull 1 when in the latched position. The lever 200 may have a dog-leg shaped part 214 which prevents the lever 200 from protruding from the hull 1 in the latching position. This also makes it easier to insert the battery pack 6 and the water jet module 10 when there are two parallel levers 200ab .

In a preferred embodiment the lever system 299 comprises two parallel levers 200a and 200b (FIG. 5). The two levers 200ab may be of the same length. The two levers 200ab may be arranged to work in concert. The two levers 200a, 200b may be connected by handle 215. The handle 215 is configured to allow a user to operate both levers 200a, 200b at the same time. Hence, they will be moved together by a user 2. The arrangement of battery pack 6 or water jet module 10 is the same on both sides (left/right), hence both sides of the battery pack preferably have a cooperation element 209, etc. Hence a user may conveniently grip handle 215 in order to move both levers 200a, 200b in first or second directions 205, 206. Handle 215 is preferably at the first end 203 of the levers 200ab. Handle 215 is preferably located aft of battery pack 6 or aft of water jet module 10 when the lever 200 is in the latching position as seen in FIG. 6a. The handle 215 is then preferably configured to be away from the nozzle 21 of the water jet 7. As seen in FIGS. 4c-6a the levers have a curvature 216 to ensure that the handle 215 is above the nozzle 21 when the board is in use. The locking mechanism 201 may be arranged to interact with a part of the handle 215. In a preferred embodiment, each lever 200a, 200b is arranged on each side of the battery pack 6. In a preferred embodiment the lever system 299 also latches the water jet housing 11 and there is one lever 200a, 200b is arranged on each side of the water jet housing and the battery pack, as can be seen in FIGS. 4c-6a.

As mentioned above, the levers are at least 50 cm long. In particular when there are two levers 200a 200b that tilt in the forward-aft direction, with a handle 215 it is preferred that the levers are longer than the length of the battery pack 6 or the water jet module 10 along the front-end rear end axis. This makes it possible to fit the handle 215 away from the water in latched position for example rear of the water jet module 10 as in FIG. 6a or in a slot rear or forward of the battery pack 6 (when there is no water jet module 10) (not shown). A lever 200 that is longer than the length of the water jet module 10 in the forward-aft direction provides fastening of the water jet module 10 along the length of the water jet module 10.

As shown in FIGS. 4-6 and 10-12 the system may comprise a hull 1, a battery pack 6 and a water jet module 10 arranged rear of the battery pack 6. The lever 200 moves in the forward-backwards direction of the hull 1 and is latched in its most rearward position.

FIGS. 10a-c shows an example of operation of lever 200. In FIG. 10a the lever 200 is in the latched position. The battery locking element 207 prevents movement of the battery pack 6 from the recess 13 by interacting with the cooperating element 209 of the battery pack 6. The lever 200 is locked in the latched position by locking mechanism 201 (FIGS. 10a and 6a). The lever 200 prevents water jet module 10 from moving from the recess 13 by interacting with protruding edge 213.

When the battery pack 6 is to be released, a user 2 unlocks locking mechanism 201, for example by pressing a button. This releases the lever 200. This enables user 2 to move the first end 203 of lever 200 in the second direction 206 as shown in FIG. 10b. This optionally makes the second end 204 move in the opposite direction. The battery locking element 207 moves away from cooperating element 209 (FIG. 11). The movement of the lever 200 also optionally makes the radial extension surface 210 come in contact with cooperating element 209 from below. Moreover, the lever 200 moves away from the protruding edge 213 of the water jet module 10. Motor pressing surface 211 presses against the upper surface of the water jet module 10, for example the protruding edge 213. This prevents the water jet module 10 to move from the recess 13 which could damage the contact elements of the electric connectors 300, 301.

As the upper end of the lever 200 is further moved in the second direction as shown in FIG. 10c, the motor pressing surface 211 keeps pressing down on water jet module 10 while moving battery pack 6 by the cooperating element 209, thereby separating connectors 300, 301. Connector 300 moves in a direction opposite to the mating direction 230.

In the final position shown in FIG. 12, the cooperating element 209 may rest on the motor pressing surface 211 which now is facing upwards and is not pressing down on the water jet module 10 anymore.

The user 2 can now remove the battery pack 6, for example using handle 23 and remove it from the recess 13. The water jet module 10 can then be removed from recess 13.

The steps in FIGS. 10a-10c are carried out in the opposite way when latching the battery pack 6 and the water jet module 10. First, the water jet module 10 is placed in the recess 13. Then the battery pack 6 is placed in the recess with the first electrical connector 300 aligned to the connector 301 of the water jet module 10. The shape of the battery pack 6 and the snug fit between battery pack 6 and recess 13 may assist with the alignment. The first end 203 of the lever 200 is then moved in the first direction 205, optionally so that the second end 204 moves in the opposite direction. The cooperating element 209 comes in contact with the battery locking element 207 which presses the cooperating element 209 and the battery pack 6 in the mating direction 230 and hence forces connectors 300, 301 together. When the lever 200 is in the latching position, shown in FIG. 10a and FIG. 6a, the battery locking element 207 prevents movement of the battery pack 6 from the recess 13 by interacting with cooperating element 209. The lever 200 moreover prevents movement of the water jet module 10 from the recess 13. The lever 200 is kept in the latching position by locking mechanism 201.

### Connectors

With reference to FIGS. 2-8 connectors 300, 301 are arranged to provide power to water jet 7 and optionally provide data exchange between battery pack 6 and water jet 7, in particular when control device 12 is placed in the battery pack 6, or part of the control device 12 is placed in the battery pack 6. Hence the connectors 300, 301 comprise at least two leads that are arranged to provide a circuit for voltage when the battery pack 6 is attached to the hull 1.

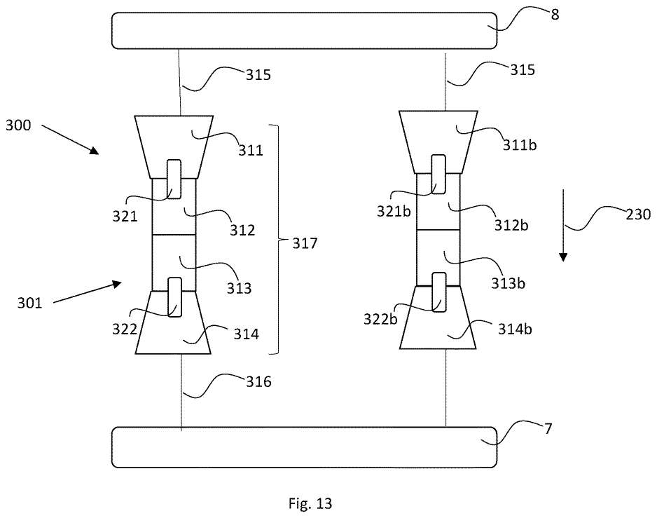

FIG. 13 shows how the leads of one circuit may be arranged. Hence, the system 100 may comprise a first set of contact elements 311, 312, 313, 314 and a second set of contact elements 311b, 312b, 313b, 314b, which will not be discussed further below. Each set of contact elements is referred to as a “contact unit 317”. In some embodiments a contact unit 317 comprises only second and third contact elements 312, 313. It is to be noted that the second connector 301 may preferably be arranged on a water jet housing 11 which is a part of water jet module 10 which comprises the water jet 7, including the motor.

First connector 300 comprises first contact element 311 and second contact element 312. Second connector 301 comprises third contact element 313 and fourth contact element 314. The first contact element 311 is arranged to provide voltage to the second contact element 312 and the second contact element 312 is arranged to provide voltage to the third contact element 313 and the third contact element 313 is arranged to provide voltage to the fourth contact element 314. The term “voltage to” means that the contact elements are in electrical contact and able to form a part of an electrical circuit.

First contact element 311 is permanently attached to the battery pack 6 and in electrical connection to battery 8, for example via lead 315. In a preferred embodiment first electrical contact element 311 is permanently mounted to a circuit board to which the battery 8 is attached, and lead 315 is provided in or on the circuit board. First contact element 311 is held in contact with second contact element 312 with a first reversible engagement means 321.

Fourth contact element 314 is permanently attached to the hull 1 or to the water jet module 10 and is in electrical connection, for example via lead 316, to electrical motor of the water jet 7. Lead 316 may be a flexible lead, such as copper wire. Fourth contact element 314 is held in contact with third contact element 313 with second reversible engagement means 322.

Third and second contact elements 312, 313 are reversibly contactable. Third and second contact element 312, 313 are brought in contact when the battery pack 6 is attached to the hull 1 or the water jet module 10. The first connector 300 is then moved or translated in a mating direction 230 so that second contact element 312 is brought in contact with third contact element 313. When the battery pack 6 is disengaged from hull 1, second contact element 312 moves in the opposite direction.

Second and third contact elements 312, 313 may form an electrical connection in any suitable manner. Second and third contact elements 312, 313 may engage by for example a form fit, an interference fit, for example between the contact elements 312, 313 or other features of the connectors 300, 301, such as a gasket or a fin/slot arrangement. Second and third contact elements 312,313 preferably easily disengage by hand, without the use of tools. Second and third contact elements 312,313 may for example be blind mate connectors, plug and socket, pogo connectors, banana connectors, or blade connectors (iPhone style). The second and third contact elements 312,313 may be self-aligning.

In various embodiments, there may be a press fit or a form fit between second and third contact elements 312, 313, as described below. Hence a certain force may be required to separate third contact element 313 from second contact element 312. The force is, however, not large enough to disengage first contact element 311 from second contact element 312, or disengage third contact element 313 from fourth contact element 314. Hence the force for separating first and second connectors 300, 301 does not disengage first and second reversible engagement means 321, 322.

Second and third contact elements 312, 313 are easily replaceable by the user, for example if they have corroded. This makes it easy to service the battery pack 6 or the hull 1 or water jet module 10. The second or third contact elements 312, 313 may be replaced by disconnecting the contact element 312, 313 and replacing it with a new contact element.

The user 2 may use the first reversible engagement means 321 to remove second contact element 312 from the first contact element 311 or use the second engagement means 322 to remove the third contact element 313 from the fourth contact element 314.

In a preferred embodiment, the outer surface of the second and third contact elements 312, 313 are cylinder-shaped, where the height axis of the cylinder is arranged along the mating direction 230.

Second and third contact elements 312, 313 may be male/female contact elements, such as a pin and a receptacle for receiving the pin. In a preferred embodiment second contact element 312 (on battery pack 6) is a female contact element and third contact element 313 is a male contact element. This prevents short circuit of the battery 8. The male and female contact elements 312,313 may attach with a reversible press fit or interference fit.

First and second engagement means 321,322 may be any suitable engagement means. The engagement means 321,322 may be integral parts of the contact elements 311, 312, 313, 314. The first and second engagement 321,322 means may be engagement means that engages the second and third contact 312, 313 elements with the first and fourth contact elements 311, 314, respectively. Examples include bayonet couplings, snap locks, retention rings etc.

The engagement means 321, 322 may comprise the first and second contact elements 311, 312 or the third and fourth contact elements, 313, 314 having matching threads whereby the first and second contact elements 311, 312 are threaded to each other, or where the third or fourth contact elements 313, 314 are threaded to each other. The second contact element 312 may be arranged to screw into the first contact element 311 in a direction opposite to the mating direction 230. The third contact element 313 may be arranged to screw into the fourth contact element 314 in the mating direction 230. The first and third contact elements 311,314 may have inner threads and the second and fourth contract elements 312,313 may have outer threads. The third or second contact elements 312, 313 may conveniently have screw drives for a mating tool which can be used to apply torque to screw or unscrew the second or third contact element 312, 313, from the first and fourth contact element 311, 314, respectively. The screw drive may be any suitable screw drive such as a slot for a screwdriver or for example Hex, external hex, Torx, or Philips. Rotation/screwing is done around an axis that is parallel to the mating direction 230. When the contact element is a female receptacle the screw drive may be placed in the bottom of the receptacle.

Connectors 300, 301 may have gaskets or O-rings to protect fourth and first contact elements 311, 314 from water.

The connectors 300, 301 comprises at least two contact units 317 that is able to provide a circuit for providing power. However, connectors 300, 301 preferably has 4 or 6, or more contact units. In a preferred embodiment there are six contact units for providing power to the water jet 10, for example for providing three phases of alternating current to the motor. There may also be at least two contact units 317 for providing sensor data from the water jet module 7 to the battery pack 6 when the control device 12 is located in the battery pack 6. The contact units 317 for providing power to the motor may be arranged to provide at least 200 Amperes more preferably provide from 50-500 Amperes. The contact units 317 for providing data may be arranged for lower current. The contact units for providing charging may be arranged to provide from 20-200 Amperes.

The battery pack 6 may comprise a circuit board to which the battery 8 is attached. The first contact element 311 may be attached to the circuit board with a device that provides torque in order to handle torque forces from the tool when second contact element 312 is rotated at replacement.

The fourth contact element 314 may be molded into the hull 1 or water jet housing 11. The fourth contact element 314 may comprise at least one molding knurl for providing torque.

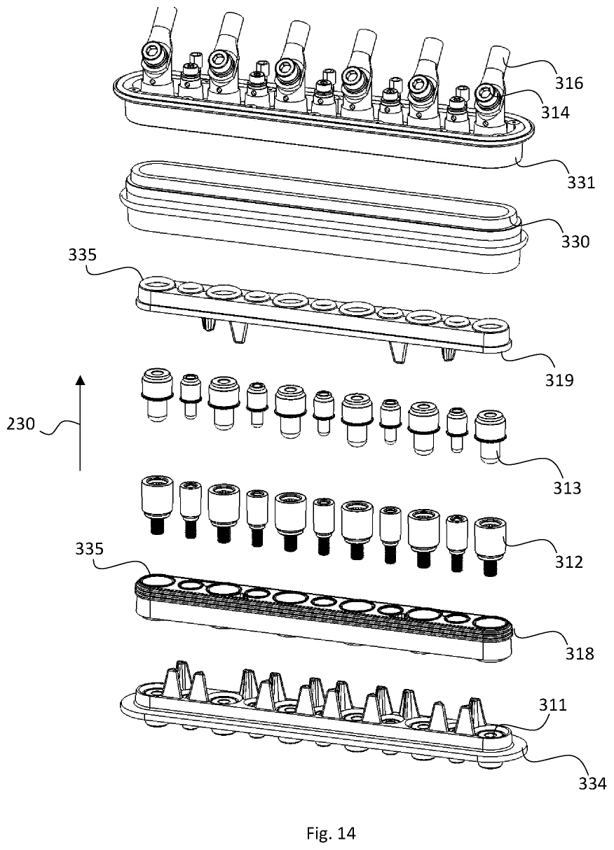

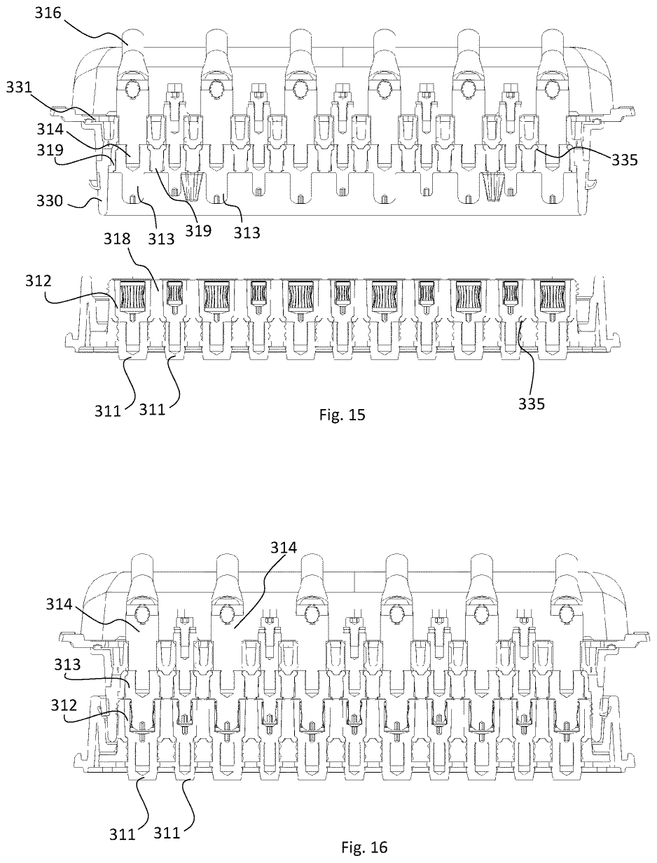

An embodiment of connectors 300, 301 is seen in FIGS. 14 to 16 which comprises six contact units 317 for power and five contact units 317 for data (smaller dimension contact units). Each of the second contact elements 312 are threaded into each of the corresponding first contact elements 311. First gasket 318 prevents water seepage to reach each of the first contact elements 311. Each of the first contact elements 311 is waterproofed separately by first gasket 318. Second gasket 319 prevents water seepage to reach each of the second contact elements 312. Each of the second contact elements 312 is waterproofed separately by second gasket 319. First or second gaskets 319 or 318 may have o-ring structures 335 that prevent leakage of water. A gasket 318, 319 may be shared by a plurality of connector units 317, for example as shown in FIG. 14.

Structural shroud 330 protects pins of third contact elements 313 from damage. Insert 334 is an insert for a plurality of first contact elements 311. In some embodiments, structural shroud 330 and second gasket 319 may comprised in one single piece.

Each of first contact elements 311 or fourth contact elements 314, or both, may be arranged so that they can be slightly (up to 20 degrees, more preferably at most 10 degrees and most preferably at most 5 degrees) biased away from the axis of the mating direction 230. For example, all of the fourth contact elements 314 may be molded in a rack or biasing element 331 which is slightly flexible. This enables the third contact elements 313 to “wiggle” together with the fourth contact element 314 to a certain degree in order to self-align with its corresponding second contact element 312 when connecting first and second connectors 300, 301. This makes it easier to attach the battery pack 6 to the hull 1. Wiggle may be provided on fourth contact element 314 or first contact element 311. However, it is preferred that it is provided with fourth contact element 314 if fourth contact element is connected to a lead 316 and where each of the first contact elements 311 is attached to a circuit board.

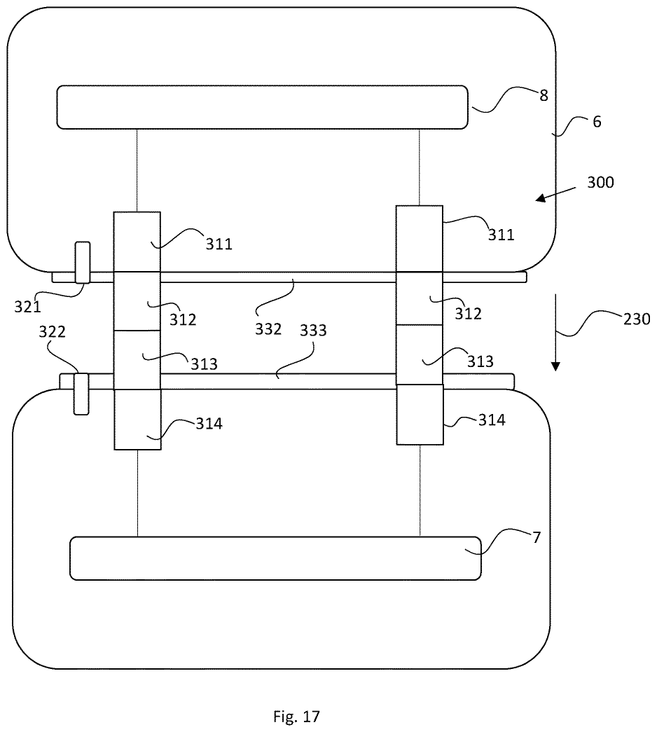

In the embodiment shown in FIG. 17, the first and second reversible engagement means 321, 322 are not arranged as a part of the contact elements, 311, 312, 313, 314. Instead, the second contact elements 312 are arranged on first holder 332 which is reversibly engaged to battery pack 6 with first reversible engagement means 321. Likewise, third contact elements 313 are attached to second holder 333 which is reversibly engaged to hull 1 or water jet module 10 with second reversible engagement means 322. Here, several or all of second or third contact elements 312, 313 may be replaced by removing holder 332 or holder 333 respectively and replacing with a new holder 332, 333 with contact elements 312, 313. Again, first and second reversible engagement means 321, 322 may be any type of suitable means, such as screws, snap locks, latches etc.

### Identification System

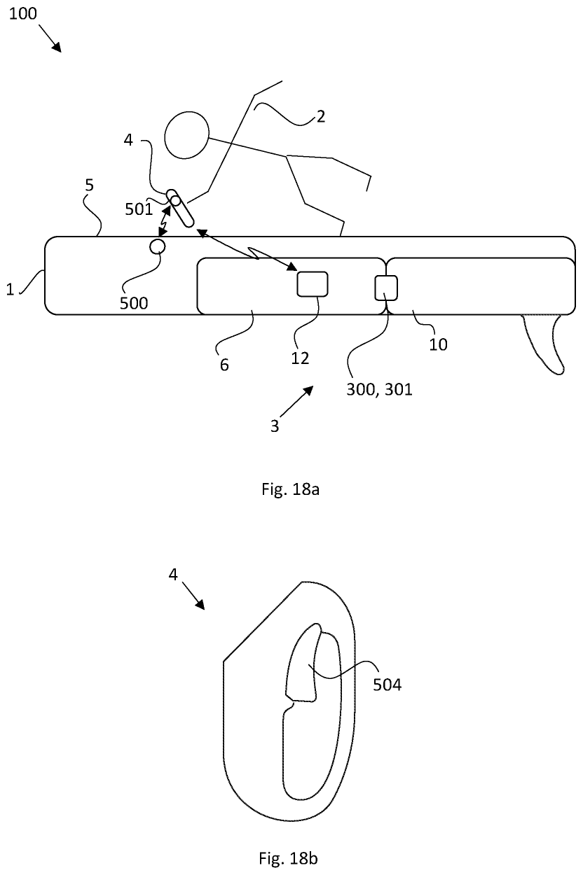

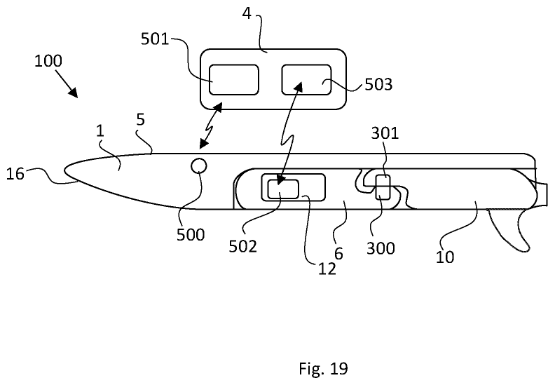

As mentioned above a user 2 riding the jet board is able to control the speed using a handheld input device 4. With reference to FIGS. 18a, 18b and 19, the handheld input device 4 (occasionally referred to as “input device 4”) and the control device 12 are arranged to be in wireless data communication with each other with the use of wireless signals. The control device 12 may have a transceiver 502 and input device 4 may have a transceiver 503. The wireless signals may be radio signals or a magneto-inductive signals. The input device 4 and the control device 12 may be arranged to communicate using both types of signals. A magneto-inductive signal may be preferred in case the hull 1 becomes submerged, for example when the user 2 is water-starting.

The handheld input device 4 is able to provide various control signals to the control device 12. The input device 4 has a sensor 45, for example a Hall sensor, or an optic encoder or a plurality of discrete contact elements. Any suitable type of sensor which is able to detect input from a user 2, in particular movement of trigger 504 may be used. Handheld input device 4 may for example have a movable trigger 504 (seen in FIG. 18b) operated by one or more fingers of the user 2, and where the position of the trigger 504 is detected by sensor 45. In a preferred embodiment the trigger 504 is operated with at least 2, 3 or 4 fingers. Typically, the speed will increase if the trigger 504 is pushed or pressed in and decreased when the trigger 504 is released. Such input from a user is coded to data in the handheld input device 4 and provided to the control device 12 as a control signal using the wireless data communication. The control device 12 receives the control signal and controls the motor, for example by adjusting battery 8 output to the motor. So, by using the handheld input device 4, a user 2 may increase or decrease the speed of the jet board.

In general, handheld input device 4 and control device 12 may exchange data using any suitable protocol, such as a short-range network, for example Bluetooth or ESP-NOW.

A network connection may be able to provide a data connection between the control device 12 and the input device 4. Each of handheld input device 4 and control device 12 may have a network identity, for example a MAC address. The control devices 12 and input device 4 may establish a network connection or carry out a network handshake in order to exchange data.

The handheld input device 4 and the control device 12 may each be referred to as “water sport network device” or “surfboard network device”. The network identity of the water sport network devices may comprise a unique identifier that identifies the water sports network device as such. For example, when Bluetooth is used, it is not suitable for a water sports network device to attempt to pair with other Bluetooth devices, such as headphones or speakers.

Sometimes several similar or identical water sports systems 100 each comprising a handheld input device 4 and a propulsion system 3 with a control device 12 may be present at the same location, for example on a beach. It is important that the handheld input device 4 only controls one single propulsion system 3, in order to avoid accidents.

The control device 12 and the input device 4 may become paired such that a control signal from the handheld input device 4 only controls one control device 12.

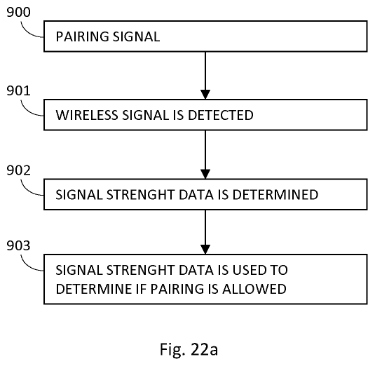

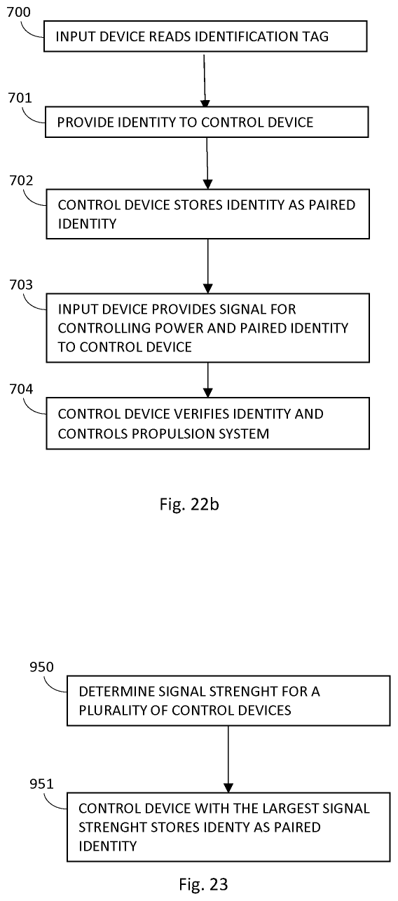

FIG. 22a shows a method for connecting network devices in a powered surfboard system 100. In step 900 the two water sports network devices enter pairing mode. Hence, each of the control device 12 and the handheld input device 4 is put in pairing mode. This may be done as described below with reference to FIG. 22b, for example when the water sports network device receives a pairing signal. For example, the control device 12, when comprised in the battery pack, may enter pairing mode when the battery pack 6 is electrically connected to the water jet module 10, or with the use of a paring button. The handheld input device 4 may enter pairing mode in various manners. For example, the handheld input device 4 may have an on/off switch and where the handheld input device 4 enters pairing mode when switched on by a user.

The further steps will now be carried out from the point of view of the handheld input device 4 but the steps may also be carried out by the control device 12. In various embodiments, certain steps may be distributed between the control device 12 and the handheld input device.

In step 901, handheld input device 4 detects a wireless signal comprising a network identity from a control device 12.

In step 902 the handheld input device 4 determines the signal strength for the wireless signal to obtain signal strength data. Signal strength is determined as is known in the art. Preferably the devices broadcast a signal comprising a network identity so that each signal (device) can be identified. For example, wireless protocols typically provide RSSI (Received Signal Strength Indication) for a data communication link between two units. Such RSSI can be used as signal strength data.

Then, in step 903, the handheld input device 4 uses the signal strength data to determine if pairing with the control device 12 should be allowed, that is if wireless data communication that enables the wireless input device 4 to provide the control signal to the control device 12 is to be established between the devices.

In various embodiments, it is determined if the signal strength is above a predetermined threshold. Hence, the wireless data communication for the control signal is established only if the signal strength indicates that the signal strength is above the threshold. A suitable signal strength threshold should be used. The threshold may be selected in relation to a suitable distance. For example, it may be useful if paring does not occur if the signal strength is such that it typically corresponds to a distance between the water sport network devices of more than from 0.5 meters to 3 meters, more preferably from 0.5 meters to 1 meter. The signal strength may depend on several factors, so the threshold should be selected accordingly.

In various embodiments, a notification is provided to the user 2 if the signal strength is below the threshold. The purpose of such notification is to prompt the user 2 to move the handheld input device 4 closer to the control device 12, in order to obtain a stronger signal such that pairing may occur. The notification may be provided in any suitable manner. For example, the indication may text on a display of the handheld device 4 or a flashing LED, tactile output such as vibration or other suitable notification means.

In various embodiments, when the handheld wireless input device 4 in pairing mode detects wireless signals from two different control devices 12 that both are in paring mode, the signal strength data is used to select the control device 12 associated with the strongest signal strength and to establish the data wireless connection that enables control of propulsion with that control device 12. This embodiment may be used together with a signal strength threshold or separate from the threshold. The determination of signal strength may involve the input device 4 carrying out handshakes with both control devices 12. Signal strength data for both connections are then determined.

In a similar manner, when a control device 12 detects more than one handheld input device 4, the handheld input device 4 that provides the strongest signal to the control device 12 may be selected for paring.

Analysis of signal strength and decision making regarding if to pair may be carried out by signal strength analysis software which may be stored in control device 12 or handheld input device 4. In some embodiments, when the signal strength data has been determined by the handheld input device 4, the signal strength data may be provided from the handheld input device 4 to the control device 12 for analysis and determination of allowability of pairing. In a similar manner, signal strength data may be provided to the handheld input device 4 from the control device 12 for analysis and determination of allowability of pairing.

The network address, such as a MAC address, may be stored in the memory of handheld device 4 or the control device or both such that if contact is lost between them, data connection that allows the control signal will be immediately established between the two network devices once the wireless signal is detected. Data connection that allows the control signal may then, in some embodiments, be established without determining signal strength.

The hull 1 preferably has an identification tag 500 that stores data representing a hull identity. The hull identity is preferably a unique identity. Any suitable combination of numbers, letters or symbols may be used for the identity. The identification tag 500 may be any type of identity tag such as a bar code, a magnetic strip, a RFID tag such an NFC tag (Near Field Communication tag). The identification tag 500 can be read using an identification tag reader 501, preferably in a contactless manner. In a preferred embodiment, the identification tag 500 cannot be read from a certain maximum distance, which preferably is at most 1 meter, more preferably at most 0.5 m and even more preferably at most 10 cm and most preferably 5 cm or 2 cm. Hence, the identification tag 500 can preferably only be read when in proximity to the tag reader 501. In a preferred embodiment the identification tag 500 is an RFID tag and an even more preferred embodiment the identification tag 500 is an NFC tag. The handheld input device 4 preferably comprises an identification tag reader 501 arranged to read the identity of the identification tag 500.

The identification tag 500 may preferably be read from the upper side 5 of the hull 1. Hence when the identification tag 500 is an RFID tag or an NFC tag it may be placed in the hull close to the upper side 5 of the hull 1. For example, in some embodiments an NFC tag may be placed in the hull 1 at a distance of from 0 mm to 50 mm, more preferably from 0 mm to 20 mm of the upper side 5. The upper side 5 of the hull 1 may have a visibly marked area 550 (FIG. 1) showing the approximate location of the identification tag 500 to aid the user 2 in finding the tag 500.

Sometimes several similar or identical watercrafts may be present at the same location. It is important that the handheld input device 4 only controls one watercraft and that is the watercraft of the user 2 intends to ride. The identification tag 500 and the identification tag reader 501 may be used to ensure that the handheld input device 4 provides instruction to the control device 12 of the correct watercraft. In particular, when the control device 12 is in a module that is releasably attached to the hull 1, and hence can be used in different hulls 1.

One way to handle this is to provide a tag reader in the same module that comprises the control device 12, for example in the battery pack 6. This makes it possible for control device 12 to use the tag reader to read an identification tag in the hull 1. The control device 12 and the input device 4 can then verify that they are working in the same hull 1. However, this makes it necessary to provide a tag reader in the battery pack and possibly also provide a separate tag in the hull because an identification tag may have to be positioned in proximity to the user and the battery pack.

An alternative solution is the method shown in FIG. 22b. In a first step 700 the identification tag reader 501 of the input device 4 reading the hull identity when in proximity to the identification tag 500. This is done for example by the user tapping the input device 4 with the tag reader 501 to a marked area 550 close to the identification tag 500. The input device 4 stores the identity in its memory 40 as a paired identity.

In step 701 the input device 4 provides the hull identity to the control device 12 using the wireless data communication. The control device 12 receives the identity. The control device 12 then, in step 702 stores, in memory 50, the identity of the hull 1 as a paired identity. This storage step is preferably done when the control device 12 receives input that triggers the storage of a new paired identity, for example when a predetermined action is carried out as described below with reference to FIG. 23 (this is one example of a pairing signal).

The memory 50 of the control device 12 is arranged to store one, and not more than one, paired identity. Likewise, the memory 40 of the input device 4 is arranged to store one, and not more than one, paired identity.

The handheld input device 4 and the control device 12 are now paired in the sense that they have stored the same hull identity as paired identities.

When the user 2 uses the handheld input device 4 to control the speed, the control device 12 may verify that the handheld input device 4 is paired to the same hull 1 as follows. In step 703 the input device provides a signal for controlling the power of the propulsion system to the control device, the signal comprising the hull identity. This is typically done when a user 2 provides input to input device 4 to control the speed.

In step 704 the control device 12 receives the control signal and, if the hull identity of the control signal matches the paired hull identity stored in the memory 50 of control device 12, the control device 12 controls the propulsion system in accordance with the control signal. Hence the control device 12 verifies that the received control signal comprises the hull identity stored as a paired identity in the memory of the control device 12.

If the control signal from the input device 4 comprises a different hull ID, the instructions in the control signal is discarded by the control device 12. Hence, the instruction (for example to decrease or increase the speed) is then not carried out. This ensures that instructions from other input devices that are within signaling range are not carried out, even if a network connection is established between a control device 12 and an input device 4.

Pairing the handheld input device 4 and control device 12 may be initiated in various manners. The control device 12 initiate pairing when it receives pairing signal. In various embodiments, a pairing signal may make the control device 12 replace a stored paired identity with a new paired identity. The pairing signal may put the control device 12 in a pairing mode. Pairing mode of the handheld input device 4 may be initiated when the tag reader 501 of the handheld input device 4 detects an identification tag 500. For example, handheld input device 4 man continuously look for a tag 500 and pair with the tag 500 that is identified.

Control device 12 may enter pairing mode in various manners. A pairing signal to the control device 12 may be triggered in various manners. For example, when the control device 12 is comprised in the battery pack, the battery pack 6 may comprise a pairing button which can be pressed by the user 2. Pairing is then initiated when the user 2 presses the pairing button. A pairing button may alternatively be placed on the water jet module 10. In other embodiments, a user 2 may initiate pairing by using an app in a portable communications device 801 (such as a smartphone, see below) that is wirelessly connected to the control device 12.

In other embodiments, a sensor may trigger a paring signal in an automatic fashion. Any type of suitable sensor may be used to initiate pairing at the control device 12. The sensor may for example be a mechanical sensor or a magnetic sensor, such as a Hall sensor. In some embodiments the pairing signal may be initiated when connecting the housing that comprises the control device 12 to the hull 1 or to a second housing such as water jet module 10. This may be sensed by a mechanical sensor, for example.

In a preferred embodiment the system 100 comprises a propulsion system 3 which comprises a battery pack 6 releasably attached to the hull 1 and a water jet 7 powered by the battery pack 6, and where the battery pack 6 is electrically connectable to the water jet 7, and where the pairing signal is generated when the battery pack is electrically connected to the water jet 7. The control device is preferably located in the battery pack 6. The water jet 7 may be provided in some embodiments as a separate water jet module 10 releasably attached to the hull 1.

For example, the control device 12 may comprise a sensor that senses the impedance or resistance of the electrical connection of the battery pack 6. When the battery pack 6 is connected to the water jet 7, the impedance in the electrical cables changes and this is detected by an impedance sensor and used as a pairing signal.

Pairing mode may be initiated during any steps 700 or 701 but before step 702.

When several people are using watercrafts at the same time and location, there is a risk that the handheld input device 4 tries to pair with the wrong control device 12. For example, there may be two (or more) control devices 12 in pairing mode at the same time because two friends are going jet boarding at the same time. The control device 12 may be in pairing mode until paired with an input device 4 and this may take a couple of minutes, or even more, so the risk is not negligible. This problem can be solved by the following arrangements and methods where in a handheld input device 4 is able to select the control device 12 that provides the strongest wireless signal and pair (i.e. provide the hull identity to) with that control device 12. It is assumed that that control device 12 is the one closest to the user 2 and therefore the control device that the user 2 indents to use.

The handheld input device 4 or the control devices 12 may be able to generate signal strength data. Signal strength is determined as is known in the art. Preferably the devices broadcast a signal comprising a network identity so that each signal can be identified. For example, wireless protocols typically provide RSSI (Received Signal Strength Indication) for a data communication link between two units. Each of the control devices 12 and the handheld input device 4 may have a network identity, for example a MAC address. Both control devices 12 may establish a network connection or carry out a network handshake with the handheld input device 4 before the signal strength data is determined.

The system 100 is arranged to compare the signal strength data, and where the system is arranged so that only the control device which has the highest signal strength stores the hull identity in the memory as a paired hull identity.

The signal strength may be determined by the handheld input device 4 which selects the control device 12 with the highest signal strength. Alternatively, the signal strength is determined by each of the control devices 12 and provided to the handheld input device 4.

The handheld input device 4 provides the hull identity to the control device 12 that it has the highest signal strength. The handheld input device 4 may have software for comparison and selection of the strongest signal for this purpose. In some embodiments, this selection task may be delegated to one of the control devices 12 by the handheld device 4 that then provide information regarding the selected control device 12 to the input device.

FIG. 23 shows a method where in step 950 the handheld input device 4 establishes a network connection with two control devices 12. Signal strength data for both connections are then determined. In step 951 the input device 4 provides the hull identity (step 701 in FIG. 22b) to the control device 12 which the input device 4 has the network connection with the highest signal strength. In some embodiments, the input device 4 provides the identity to both control devices 12, but provides a storing signal to the control device 12 with the highest signal strength.

The difference in signal strength may have to be above a threshold in order for a selection of one control device 12 to be carried out. If the signal strength difference is below a threshold, the input device 4 may, in certain embodiments, not pair with a control device 12 but instead provide an indication or notification to a user 2 that prompts the user to move one control device 12 (for example a battery pack 6 containing a control device 12) closer to the input device 4 so as to provide a larger difference in signal strength. The indication may be provided to a user 2 in any suitable manner for example an indicator on or from the handheld device such as a message on an LCD, light, sound, tactile feedback or by a message to an app on the user's smartphone.

In some embodiments, the system 100 has a safety feature which disables the handheld input device 4 if communication between the handheld input device 4 and the control device 12 is lost, for example if the distance between the handheld input device 4 and the control device 12 is such that the communication is lost, for example because the user has fallen overboard (“kill switch”). The control device 12 may then automatically stop the motor. For example, if control device 12 notices that there is no signal from input device 4, or if signal strength is below a predetermined threshold, the control device may restrict power to the motor. The system 100 may be arranged to stop when the distance between the input device and the control device 12 is at least 10 meters, more preferably 5 meters and most preferably 3 meters. In order for the user 2 to continue riding the board, the user 2 may have to tap the handheld input device 4 to the identification tag 500 in the hull 1 in order to reset the input device 4 (step 700 above). The input device 4 provides a control signal together with the identity and the control device 12 then verifies the identity as set out in steps 703 and 704 above. This ensures that the handheld input device 4 controls the correct control device 12.

### Network Connectivity

Control device 12 may have network connectivity for exchanging data for various purposes, such as for updating software, including updating control parameters for the propulsion system (maximum speed, acceleration profiles), providing identity of hull 1 to a portable communications device 801 and more. For example, a portable communication device 801 may have an app for providing information about the system 100 and also controlling various parameters of the system. For example, the portable communication device 801 may display, on a display, when receiving the identity of the hull 1 from the control device 12, one or more of the following: identity of hull, an image of the hull 1, an identity of a battery pack 6, and an identity of a water jet pack 10.

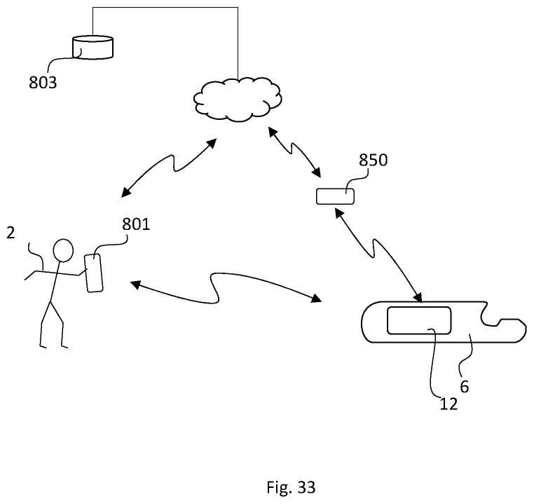

With reference to FIGS. 32 and 33, the control device 12 may be able to connect to a portable communication device 801 such as a smart phone (for example an iPhone) using suitable hardware and software such as Bluetooth connectivity. Control device 12 may have network connectivity for connection to server 803. Portable communications device 801 is able to communicate in a cellular network 802. The control device 12 may have any suitable type of wireless connectivity in order to communicate with portable communications device 801.

A user 2 may be able to make input to communications device 801 for example using a touch screen. The communication device 801 may make or provide output to a user 2, for example on a screen.

With reference to FIG. 32, a communications device 801 may be used to control the charging of the battery 8. Battery 8, preferably battery pack 6, is connectable to charger 800 which is powered by a power source 804, which may be standard electric power outlet. Charger 800 has a connector that can be reversibly connected to connector 300. Charging may be controlled in various manners to optimize charging times and battery life. Software for controlling charging may be provided in control device 12 or charger 800. Hence control device 12 may measure various parameters of battery 8, such as charge state (State of Charge, SoC), current charging current/voltage and battery temperature, and to use this to adapt charging. Charging may be adapted to charge the battery as much as possible while taking battery life and other parameters into account. Control device 12 may detect charge state (% charge) of battery 8 as is known in the art. Data contact units 317 may be used to exchange data between control device 12 and charger 800.

A user 2 may control the charging by providing a control signal from communications device 801 to control device 12. Information about charge state may be provided from control device 12 to communication device 801, which may display it on a screen for the user 2. For example, the control device may report that charging is at 80% and display that information to a user 2. A user 2 may be able to provide a charging control signal from the communications device 801 to the control device 12. For example, a user 2 may provide signal that makes the charger 800 charge the battery 8 as much as possible (top-up). This can be used by the user 2 to initiate top-up charging when the user 2 is not close to the battery 8 and charger 800, for example when anticipating using the jet board later during the day. Some types of batteries, in particular Lithium-ion type batteries should not be at more than 80% charge for a prolonged period, and this can be avoided using the described battery charge control.

With reference to FIG. 33, control device 12 may connect to a wireless access point device 850, such as a device that provides Wi-Fi connectivity to provide internet connection. A wireless access point device 850, such as a Wi-Fi access point, is typically associated with an identity name and a password that is used to connect wirelessly to the wireless access point device 850 in order to get internet access. A portable communication device 801 may share the name and password with the control device 12 as follows. The portable communication device 801 establishes a connection to the wireless access point device 850 by using the identity and the password. The portable communication device 801 establishes a short-range network connection, such as a Bluetooth connection, with the control device 12. The portable communication device 801 then provides the identity and the password for the wireless access point device 850 to the control device 12. The control device 12 then uses the identity and the password for the wireless access point device 850 to connect to the wireless access point device 850 to obtain internet connectivity. The sharing of identity may be dependent on a user allowing the sharing. The portable communication device 801 may prompt a user 2 to allow sharing of name and identity for the wireless access point device 850, for example when the short-range network connection with the control device 12 is established. When a short-range network connection between communication device 801 and control device 12 is detected by communication device 801, communication device may prompt the user to allow sharing of the connection details with the control device.

### Carrying System

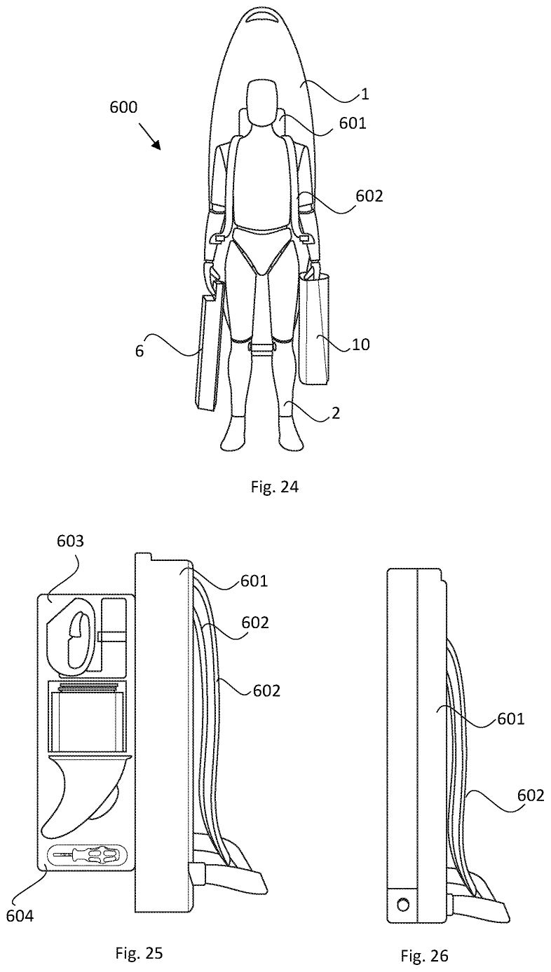

The system 100 may comprise a carrying system 600, an example of which is shown in FIGS. 24-26 arranged for being worn by a user 2 such that a carrier 601 is exposed on the back of the user 2, where the carrier 601 of the carrying system 600 is arranged to interact with a hull member to reversible fasten the hull 1 to the carrying system 600, in a manner such that the hull 1 may be carried on the back of the user 2. The hull member may for example be a part of the fastening mechanism, for example lever 200 of the hull 1. The carrying system 600 may have one or two shoulder straps 602, which may enable a user to wear it like a backpack.

When the carrying system 600 is worn by a user 2, carrier 601 is exposed on the back of the user 2. By using hull member of fastening mechanism, for example lever 200, the hull 1 can be reversibly fastened to the carrier 601. For example, the carrier 601 may be arranged to interact with the lever 200.

The hull 1 may for example be carried with the fin 400 or the fin slot 401 downwards and the fin or the fin slot 401 towards the user 2.

Preferably the hull 1 can be carried using the carrying system with the hull 1 not wobbling. Hence the hull 1 is preferably fixated to the carrying system 600 when fastened to carrying system 600.

When the hull 1 comprises a recess 13 for receiving the battery pack 6 or the water jet module 10 the carrier 601 may be arranged to closely fit in the recess 13 of the hull 1, when at least one of battery pack 6 or water jet module 10 is not present in the recess 13. The outer shape of carrier 601 may be arranged to fit in the recess 13 of the hull 1 in a manner that mimics the outer shape of a battery pack 6 or a water jet module 10, or both. Hence the carrier 601 may have a shape similar or identical to the outer shape of battery pack housing 9 or water jet housing 11 or a combined outer shape of battery pack housing 9 and water jet housing 11.

The carrier 601 may be arranged to interact with the fastening system of the hull 1 in the same way as the battery pack 6 or the water jet module 11 interacts with the fastening system. For example, the carrier 601 may be arranged to interact with a lever 200 of the hull in a reversible manner to reversibly fasten the hull 1 to the carrier 601.

In a preferred embodiment the carrier 601 comprises a storage compartment 603 arranged to fit in the recess 13 of the hull 1 when the hull 1 is fastened to the carrying system 600. The storage compartment 603 can be used for storing, for example the handheld input device 4, fin 400, or personal belongings. The storage compartment 603may be a container that can be reversibly closed and opened. For example, the storage compartment 603 may have a door 604. The storage compartment 603 may be waterproof.

By using the carrying system 600 the hull 1 can conveniently be transported, for example from a car to the beach. The battery pack 6 may be carried in one hand and the water jet module 10 can be carried on the other hand. The water jet module 10 may be held in the water jet inlet and the battery pack 6 may be carried in the handle 23, for example.

### Fin

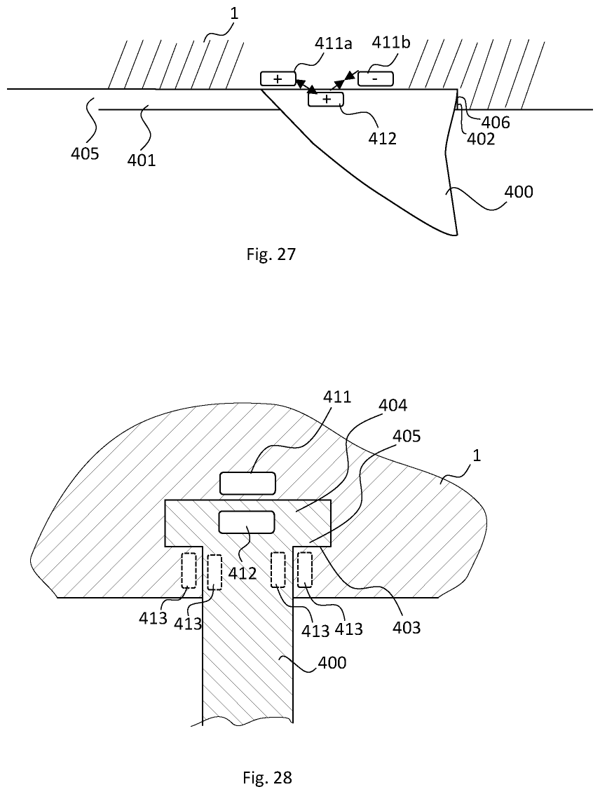

FIGS. 27-31 shows a system for a fin 400. Fin 400 is provided to provide course stability in the water as known in the art of watercrafts, such as surf boards and windsurfing boards. Fin 400 is preferably reversibly attached to the hull 1 or detachable part of the system 100 such as the battery pack 6 or the water jet module 10 in a manner that fin 400 protrudes downwards in the water when a user 2 is riding the jet board. In a preferred embodiment the fin 400 is reversibly attached to the water jet module 10 and the water jet module 10 is reversible attached to the underside 14 of the hull 1, for example in recess 13. Removing the fin 400 from the hull 1 makes it easy to transport the system 100 and replacing or exchanging the fin 400. Various size fins 400 may be used for different types of riding and wave conditions. Also, a fin 400 may break and need replacement.

The fin 400 may be slidably arranged in a horizontal slot 401 which is arranged in the forward-rear axis of the hull 1. The slot 401 may have an opening 405 to receive the fin 400. The slot 401 has a stopper 402 in the rearward end. The stopper 402 limits the movement of the fin 400 rearwards.

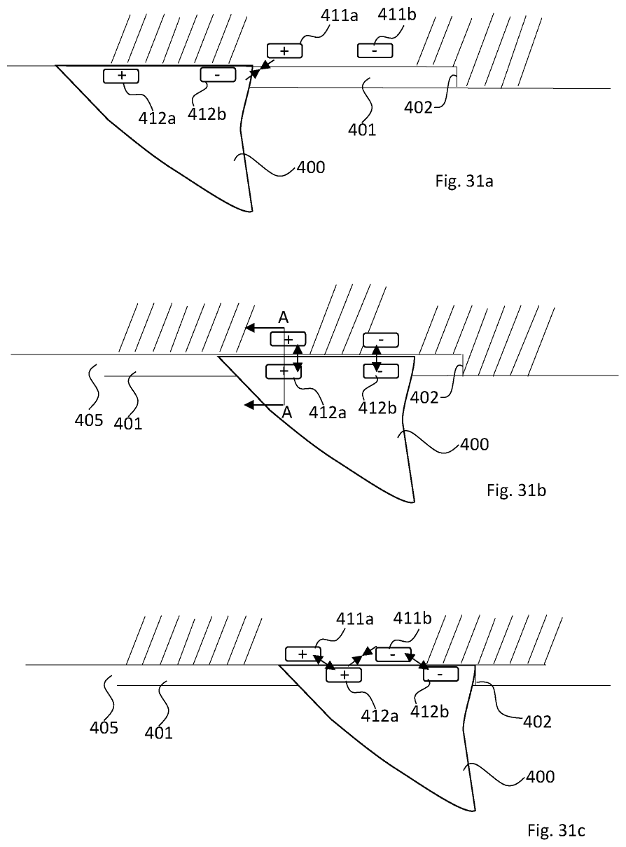

With reference to FIG. 28, which is a section in the line A-A show in FIG. 31b, the slot 401 preferably has flanges 403 in which corresponding protrusion 404 of the fin 400 can rest against to keep the fin 400 attached to the slot 401. In various embodiments the flange 403 may be arranged along a part of the forward-aft direction of the slot 401 and the slot 401 has one or more openings into which corresponding protrusions 404 are inserted from below. Dashed magnets 413 indicate alternative possible positions of magnets 411, 412.

In a preferred embodiment, there is a magnet (hull magnet 411) and part of the fin 400 has a magnet (fin magnet) 412 arranged to interact with the magnetic field of the hull magnet 411 to prevent the fin from sliding from the slot 401. In particular, the magnets 411, 412 are arranged to prevent the fin 400 from sliding forward in the slot 401.

In the following, it will be described how the hull magnet 411 is arranged in the hull 1, but what is said also applies to the situation where the fin 400 is reversibly attached to a part that is reversibly attached to the hull 1, such as the water jet module 10.

Looking at FIG. 27, The hull 1 has a magnet (hull magnet) 411 and the upper part of the fin has a magnet (fin magnet) 412. The hull magnet 411 and the fin magnet 412 are arranged so that their respective magnetic fields are able to interact when the fin 400 is arranged in the slot 401. The hull magnet 411 and the fin magnet 412 are arranged so that their interaction prevents the fin 400 from sliding forward to a certain extent. The force may be overcome by manually sliding the fin 400 in the slot 401, but strong enough to keep the fin 400 in place in most circumstances, for example when carrying the hull 1 with the fin 400 attached. When riding the jet board in water, the water flowing past the fin 400 will press the fin 400 rearwards which prevents the fin 400 from sliding forward and leave the slot 401.

FIG. 27 shows an embodiment with two hull magnets 411a and 411b and one fin magnet 412. The first hull magnet 411a has the same polarity arrangement as the fin magnet 412 making them repulse each other as indicated by the arrows. Each magnet 411, 412 has a +side and an-side but for simplicity only one pole is indicated in the drawings. The second hull magnet 411b has the opposite polarity arrangement as the fin magnet 412 making them attract each other, as indicated with the arrows. When the fin 400 is in its most rearward position as shown in FIG. 27, the rear end 406 of the fin 400 rests against the stopper 402 and the first hull magnet 411a which is arranged forward of the fin magnet 412 repulses the fin magnet 412, thereby keeping the fin 400 pushed rearwards to the stopper 402. The second hull magnet 411b, which is arranged rearwards of the fin magnet 412, exerts a force on the fin magnet 412 in the same direction (rearwards).

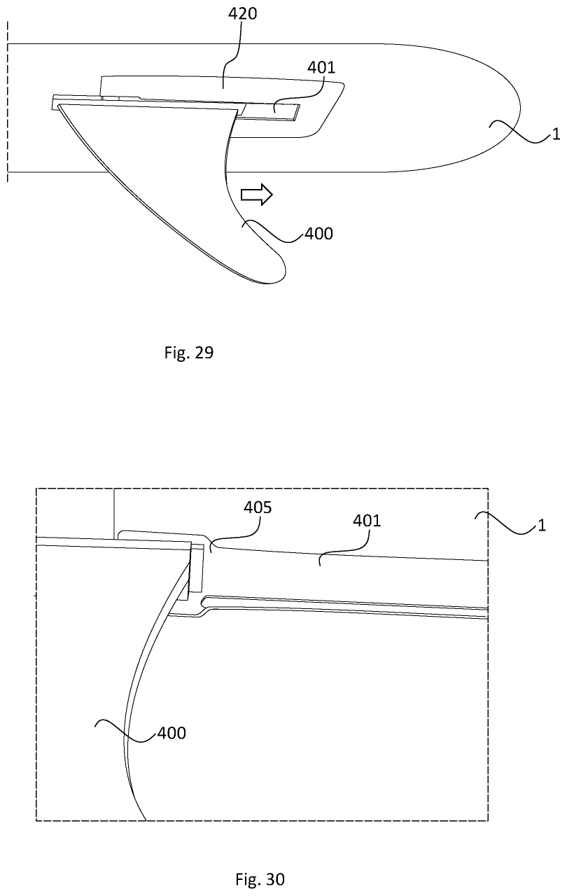

In various embodiments the hull 1 may have only one of first or second hull magnets 411ab. Moreover, the arrangement shown in FIG. 29 may be reversed so that, in various embodiments, the fin 400 may have first and second fin magnets 412ab, and there is only one hull magnet 411.

The embodiment shown in FIGS. 31a-c will now be described. FIGS. 31a-c show how fin 400 is slid backwards in slot 401 to its final position in FIG. 31c. Here, there are first and second hull magnets 411ab and first and second fin magnets 412ab. As shown in FIG. 31c, when the fin 400 is in its most rearward position, the first hull magnet 411a is arranged forward of the most forward fin magnet 412a, the two magnets being repulsive. The second hull magnet 411b is arranged rearwards of the first fin magnet 412a but forward of the second fin magnet 412b. The distance between first and second hull magnets 411ab is approximately the same as the distance between the first and second fin magnets 412ab. The first fin magnet 412a and the second hull magnet 411b attract each other. The second hull magnet 411b and the second fin magnet 412b repulse each other.

As shown in FIG. 31a, when sliding the fin 400 into the slot 401, the first hull magnet 411a and the second fin magnet 412b attract each other. This facilitates sliding of the fin 400 backwards until the situation shown in FIG. 31b. Here the repulsing forces between the magnets are at a maximum, and are overcome by the user 2 continuing sliding the fin 400 rearwards, until first fin magnet 412a and second hull magnet 411b starts to attract each other and the fin 400 snaps rearwards. The fin 400 is now kept in place with a certain force, but can be easily removed by a user 2 by sliding it forward.

Magnets 411, 412 may be arranged on the side of slot 401, for example in the positions 413 as shown in FIG. 28.

FIGS. 29 and 30 shows examples of a slot 401 and opening 405. In some embodiments the slot 401 is provided in fin box 420 attached to a main part of the hull 1 as is known in the art.

The above arrangement with magnets is a provides convenient means to keep a fin 400 in place. It's easy to remove the fin 400 without tools. Above it has been described how the fin 400 is attached to powered water sports system such as powered surfboard. However, the attachment system for a fin 400 may be used for windsurfing boards, kite boards, paddle boards or regular wave surf boards.

It is understood that certain embodiments of methods and system described herein are computer-implemented, using digital computer equipment. The various embodiments and components described herein such as handheld input device 4, control device 12 and communication between these components uses digital computer technology for storing and handling digital information and signals as well as suitable hardware and software, including for example suitable digital processors, digital memories, input means, output means, buses and communications interfaces. A user may be able to make input using for example buttons or portable communications device 801 such as a smartphone (iPhone) to make input. The communications device 801 may for example connect to a second device herein using Bluetooth.

The methods herein can be implemented with any suitable combination of software and hardware. Any suitable programming language may be used for the software units and methods described. Data communication in the system may be implemented using suitable networking technologies and protocols, inducing cellular communication such as 3G, 4G and 5G, LoRa, Wi-Fi or Bluetooth, or Ethernet. A cellular network system such as a 3G, 4G, 5G or 6G system may provide internet connectivity. Data communication can be wireless, or wire bound. Information may be exchanged over a wide area net such as internet. Data communication in system 100 may be encrypted. Communication between input device 4 and control device 12 may be carried out using any suitable schedule. The methods herein may be implemented using instructions or software stored on a non-volatile memory.

It is realized that everything which has been described in connection to one embodiment is fully applicable to other embodiments, as compatible. The division of the detailed description using headings is only intended to assist the reader and does not limit combination of the various embodiments and features described herein. Hence, the invention is not limited to the described embodiments, but can be varied within the scope of the enclosed claims. While the invention has been described with reference to specific exemplary embodiments, the description is in general only intended to illustrate the inventive concept and should not be taken as limiting the scope of the invention. The invention is generally defined by the claims.

### CLAUSES

Then invention may be claimed as follows.

### Charge Control Clauses

1. A method involving a powered surfboard system comprising
   a hull,
   a propulsion system for providing propulsion in the water, the propulsion system comprising a battery,
   the battery being rechargeable and reversibly connectable to a battery charger, the battery optionally being provided in a battery pack that is releasably attached to the hull, a control device arranged to control the current or voltage provided to the battery from the battery charger, the control device being arranged in the hull or in the battery pack, the method further involving a portable communication device having an input means, the portable communication device being in wireless communication with the control device by means of a cellular network system, the method comprising,
   the portable communication device receiving input from a user,
   the portable communication device providing a charging control signal to the control device, the control device, in response to receiving the charging control signal, controlling the voltage or current provided to the battery when charging.
2. The method of clause 1 comprising the control device providing information about the charging state of the battery to the portable communications device.
3. The method of clause 1 or 2 where the charging control signal makes the charger top up the charge in the battery.
4. The method of any one of clauses 1 to 3 where the portable communications device provides the charging control signal in response to the input from the user.

### Network Connectivity Clauses

1. A method involving a powered surfboard system comprising
   a hull, the hull optionally comprising a hydrofoil,
   a propulsion system for providing propulsion in the water,
   a control device arranged to control the propulsion system, the control device comprising a processor and a memory, the control device being arranged in the hull or in a housing reversibly attachable to the hull,
   the method further involving a portable communication device having an input means, the control device and the portable communication device being configured to establish a short-range wireless network
   a wireless access point providing internet connectivity said wireless access point being different from the portable communications device, the wireless access point having an identity and being associated with a password,
   the method comprising:
   the portable communication device establishing a connection to the wireless access point by using the identity and the password,
   the portable communication device, establishing a short-range network connection with the control device, then
   the portable communication device providing the identity and the password for the wireless access point to the control device, then
   the control device using the identity and the password for the wireless access point to connect to the wireless access point to obtain internet connectivity.

### Backpack Clauses

1. A system comprising a powered surfboard comprising
   a hull, the hull optionally comprising a hydrofoil,
   a propulsion system comprising a battery pack releasably attached to the hull,
   the system further comprising a fastening mechanism for releasably fastening the battery pack to the hull, the fastening mechanism comprising at least a hull member of the hull which interacts with the battery pack in a reversible manner,
   a carrying system arranged for being worn by a user such that a carrier is exposed on the back of the user, where the carrier of the carrying system is arranged to interact with the hull member to reversibly fasten the hull to the carrying system, in a manner such that the hull may be carried on the back of the user.
2. The system of clause 1 where the hull comprises at least one recess for the battery pack and where the carrier is arranged to fit in the recess of the hull when the hull is fastened to the carrying system.
3. The system of clause 2 where the carrier comprises a storage compartment arranged to at least partly fit in the recess of the hull when the hull is fastened to the carrying system.
4. The system of clause 3 where the storage compartment is a container that can be reversibly closed and opened.
5. The system according to any of clause 1 to 4 where the propulsion system comprises a water jet module which is reversibly attached to the hull,
   where each of the battery pack and the water jet module can be carried in one hand.

### Fin Clauses

1. A water sports system comprising a hull and a fin, the fin being reversibly attached to the underside of the hull, or a part that is reversibility attached to the hull, the fin being slidably arranged in a horizontal slot, said slot being arranged parallel to a forward-aft axis of the hull, said slot having a stopper in the rear end arranged to prevent the fin from moving rearward, where the hull or the part where the slot is arranged has arranged therein a magnet (hull magnet), the upper part of the fin having magnet (fin magnet) being arranged to interact with the magnetic field of the hull magnet to prevent the fin from sliding forward in the slot.
2. The water sports system according to clause 1, where the hull magnet and the fin magnet are arranged to repulse each other and where the hull magnet is arranged forward of the fin magnet when the fin is in its most rearward position in the slot.
3. The water sports system according to clause 2 comprising a second hull magnet arranged in the hull said second hull magnet being arranged to attract the fin magnet and being arranged rearward of the fin magnet when the fin is in its most rearward position in the slot.
4. The water sports system according to clause 3 comprising a second fin magnet arranged to repulse the hull magnet said second fin magnet being arranged rearward of the second hull magnet when the fin is in its most rearward position.
5. The water sports system according to clause 1 where the hull magnet and the fin magnet are arranged to attract each other and where the hull magnet is arranged rearward of the fin magnet when the fin is in its most rearward position in the slot.

### Connector Clauses

1. A powered surfboard comprising a hull, a propulsion system comprising a water jet, said water jet comprising an electrical motor, the propulsion system further comprising a rechargeable battery pack for providing power to the electrical motor, said battery pack being releasably attachable to the hull, the water jet optionally being provided in a water jet module releasably attached to the hull,
   said battery pack having a first electrical connector and the motor being electrically connected to or connectable to a second electrical connector, where the first and second connectors are configured to form a lead for voltage between the battery pack and the motor when the battery pack is attached to the hull, where the first connector comprises first and second contact elements, where the first contact element is arranged to provide voltage from the battery to the first contact element and the first contact element is arranged to provide voltage to the second contact element,
   first and second contact elements being held in contact with a first reversible engagement means,
   the second connector comprising third and fourth contact elements where the fourth contact element is arranged to provide voltage to the motor from the third contact element and the third contact element is arranged to provide voltage to the fourth contact element,
   the third and fourth contact elements being held in contact with a second reversible engagement means,
   where the second and third contact elements are reversibly contactable and are arranged to form a lead when the battery pack is translated in a mating direction in relation to the hull, where the second and third contact element may be disengaged by translating the battery pack in a direction opposite the mating direction, with a force that does not disengage the first or second reversible engagement means.
2. The system of clause 1 where the first and second engagement means are engagement means that engage the second and third contact elements with the first and fourth contact elements, respectively.
3. The system of any one of clause 2 or 3 where the reversible engagement means comprises the first and second contact elements, or the third and fourth contact elements, having matching threads whereby the first and second contact elements are threaded to each other, or where the third or fourth contact elements are threaded to each other.
4. The system of clause 3 where the second contact element is threaded to the first contact element or where the third contact element is threaded to the fourth contact element where the second or third contact element, respectively, is arranged to screw into or onto the first and fourth contact element, respectively, in the mating direction or a direction opposed to the mating direction.
5. The system of clause 3 or 4 where the first and third contact element has inner threads and the second and fourth contact element has outer threads.
6. The system of any one of clauses 1 to 5 where the outer surface of the second and third contact elements are cylinder-shaped, where the height axis of the cylinder is arranged along the mating direction.
7. The system of any of clauses 1 to 6 where the first connector is a female connector, and the second connector is a male connector.
8. The system according to any one of clauses 1 to 7 where the battery pack comprises a circuit board and the first contact element is attached to the circuit board of the battery pack.
9. The system of clause 8 where the battery is attached to the circuit board.
10. The system according to any one of clauses 1 to 9 comprising at least one gasket or O-ring arranged to prevent water to reach the contact elements.
11. Method of replacing a contact element in a system according to any one of clauses 1 to 10 comprising detaching the first or second engagement means to disconnect the second or third contact elements and replacing said second or third contact element.

### Lever Clauses

1. A water sports system comprising a hull, a propulsion system, said propulsion system comprising a battery pack being releasably attachable to the hull, said hull having a lower side with a recess for releasably receiving a least a part of the battery pack, the battery pack having a first electrical connector arranged to mate with a corresponding second electrical connector in the hull or in a water jet module which is releasably attachable to the hull, the hull having a lever system attached to the hull, the lever system comprising at least one latching lever tiltable in a first direction and a second direction which is opposite to the first direction, where the lever is configured to assume a latching state which limits the movement of the battery pack (6) from the recess, where the latching state is achieved by moving the lever in the first direction and the open state is achieved by moving the lever in the second direction.
2. The system according to clause 1 where hull has a front end-rear end axis and the lever tilts along the front-end rear end axis.
3. The system of clause 2 where the lever system comprises two parallel levers arranged to be operated in concert, where the two levers are connected by a handle and where the handle is arranged to be aft of the battery pack when the levers are in the latched position.
4. The system of clause 1 or 2 where the lever system has a battery moving part (208) arranged to at least partly move the battery pack (6) from the recess when the lever is moved in the second direction.
5. The system according to any one of clauses 1 to 3 where the first connector is arranged to mate with the second connector in a mating direction and where the lever is arranged to press the battery pack in the mating direction when the lever is moved in the first direction.
6. The system of any one of clauses 1 to 5 where the propulsion system additionally comprises a water jet module being releasably attachable to the hull and where the recess is configured to receive at least a part of the water jet module, such that the battery pack, when received by the recess, is arranged in front of the water jet module, where the water jet module is prevented from leaving the recess when the lever is in the latching state.
7. The system of clause 6, where the lever system comprises two parallel levers arranged to be operated in concert,
8. The system of clause 7 where the two levers are connected by a handle, where hull has a front end-rear end axis and the levers tilt along the front-end rear end axis, and where the handle is arranged to be aft of the water jet module when the levers are in the latched position.
9. The system of clause 8 where the length of the levers is at least longer than the length of the battery pack or the water jet module along the front-end rear end axis.
10. The system of any one of clauses 6 to 9, wherein the front end of the battery pack is prevented from leaving the recess by a battery pack retention member arranged in a front part of the recess, the battery pack retention member being a part of the hull, wherein a rear end of the battery pack is prevented from leaving the recess by the lever system, when the lever is in the latched state, interacting with a cooperating element arranged on the battery pack, and where the water jet module is prevented from leaving the recess by the lever, when the lever is in the latched state.
11. The system of any one of clauses 6 to 10 where the lever system comprises a motor pressing surface configured to press against the water jet module (10) when the lever is moved in the second direction.
12. The system according to any one of clauses 1 to 11 where the lever is tiltably attached to the hull 1 with a four-bar linkage.
13. The system according to clauses 11 and 12 where the motor pressing surface is comprised in one of the non-hull members of the four-bar linkage.
14. The system according to any one of clauses 2 to 13 where the lever, the battery pack and the hull and optionally the water jet module 10 are arranged such that the lever, when in the latching position, is received in a slot formed by a space between the hull and the battery pack or the hull and the water jet module, said slot being in the forward-rear direction of the hull.
15. The system according to any one of clauses 1 to 14 where the length of the lever is at least 50 cm.

### Identification System Clauses

1. A method involving a powered surfboard system comprising
   a hull, the hull optionally comprising a hydrofoil,
   a propulsion system for providing propulsion in the water for the hull,
   a control device arranged to control the propulsion of the propulsion system,
   a wireless input device arranged to be held in a hand by a user,
   where the wireless input device and the control device are arranged to be in wireless data communication with each other, such that the wireless input device may provide a control signal that controls the propulsion system, the control device and the wireless input device being referred to as surfboard network devices,
   the method comprising the steps:
   a) a first surfboard network device detecting a wireless signal comprising a network identity from a second surfboard network device, the second surfboard network device being a handheld input device when the first surfboard network device is a control device and vice versa,
   b) the first network device determining signal strength for the wireless signal to obtain signal strength data,
   c) the first or second surfboard network device using the signal strength data to determine if the wireless data communication that enables the wireless input device to provide the control signal to the control device is to be established between the surfboard network devices.
2. The method of clause 1 where the wireless data communication that enables the control signal is established only if the signal strength indicates that the signal strength is above a threshold.
3. The method of clause 2 where a notification is provided to a user if the signal strength is below the threshold.
4. The method of any one of clauses 1 to 3 where,
   when the first surfboard network device is a control device which detects wireless signals from two different wireless input devices, the signal strength data is used to select the wireless input device with strongest signal and to establish the wireless data connection with that wireless input device
   or
   when a first wireless input device is a handheld wireless input device which detects wireless signals from two different control devices, the signal strength data is used to select the control device associated with the strongest signal strength and to establish the data wireless connection with that control device.
5. The method of any one of clauses 1 to 4 where a surfboard network device is configured to carry out step c) when it receives a pairing signal.
6. The method of clause 5 where the propulsion system comprises a battery pack, the battery pack being releasably attached to the hull, the propulsion system further comprising a water jet arranged to be powered by the battery pack, and where the battery pack is electrically connectable to the water jet, and where the pairing signal is provided to the control device when the battery pack is electrically connected to the water jet.
7. A system comprising
   a hull, the hull optionally comprising a hydrofoil,
   a propulsion system for providing propulsion in the water for the hull,
   a control device arranged to control the propulsion of the propulsion system,
   a wireless input device arranged to be held in a hand by a user,
   where the wireless input device and the control device are arranged to be in wireless data communication with each other, such that the wireless input device may provide a control signal that controls the propulsion system, the control device and the wireless input device being referred to as surfboard network devices, network devices being configured to:
   when detecting a wireless signal comprising a network identity from a second surfboard network device, determining signal strength for the wireless signal to obtain signal strength data, and to use the signal strength data to determine if the wireless data communication that enables the wireless input device to provide the control signal to the control device is to be established between the surfboard network devices.

What is claimed is:

1. A powered surfboard system comprising:
a hull having a forward-rearward axis and a lower side; and
a propulsion system comprising a battery pack and a water jet module, the battery pack and the water jet module being releasably attached to the hull, the battery pack being configured to provide power to the water jet module;
wherein:
the battery pack comprises a rechargeable battery and a battery pack housing;
the lower side of the hull has a recess configured to receive the battery pack and the water jet module such that part of the battery pack housing is at least partly submerged in water when the surfboard is ridden;
the battery pack is arranged forward of the water jet module in the recess;
the battery pack has a first electrical connector arranged to mate with a second electrical connector arranged on the water jet module;
the first electrical connector is arranged on a rearward-protruding part of the battery pack, and the second electrical connector is arranged on a forward-protruding part of the water jet module; and
the rearward-protruding part of the battery pack is arranged below the forward-protruding part of the water jet module when the hull is oriented as it would be when a user is riding the surfboard in the water.

2. The powered surfboard system of claim 1, wherein an outer surface of the battery pack and an outer surface of the water jet module are configured to form a substantially flush outer surface together with an outer surface of a lower side of the hull.

3. The powered surfboard system of claim 1, wherein the hull has an upper side and the hull as an upper side-lower side axis, and where the connectors are arranged to mate in a mating direction which is essentially parallel to the upper side-lower side axis.

4. The powered surfboard system of claim 1, wherein connectors comprise a plurality of contact units and where all contact units are arranged in a straight line that is horizontal and perpendicular to the forward-rearward axis of the hull.

5. The powered surfboard system of claim 1, wherein the battery pack and the water jet module are reversibly attached to the hull with a fastening mechanism comprising a lever system, the lever system comprising a latching lever that is tiltable in the forward-rearward direction and where the latching lever is configured to be in an latching state where the battery pack and the water jet module are prevented from leaving the recess, and in an open state where the battery pack and the water jet module may be removed from the recess.

6. The powered surfboard system of claim 5, wherein the latching state is achieved by moving the lever in the rearward direction and the open state is achieved by moving the lever in the forward direction, where the lever system has a battery moving part arranged to at least partly move the battery pack from the recess when the lever is moved in the forward direction.

7. The powered surfboard system of claim 5, wherein the lever system comprises a motor pressing surface configured to prevent water jet module to move out of the recess when the lever is moved in the forward direction.

8. The powered surfboard system of claim 5, wherein the length of the lever is longer than the length of the water jet module in the forward-rearward direction.

9. The powered surfboard system of claim 5, wherein there are two parallel latching levers each arranged to tilt in the forward-rearward direction on each side of the battery pack.

10. The powered surfboard system of claim 9, wherein the two parallel latching levers are connected by a handle.

11. The powered surfboard system of claim 10, wherein the handle is arranged to be aft of the water jet module when the levers are in the latching state.

12. The powered surfboard system of claim 5, wherein the lever, the battery pack and the hull and the water jet module are arranged such that the lever, when in the latching position, is received in a slot formed by a space between the hull and the battery pack and the hull and the water jet module, the slot being in the forward-rear direction of the hull.

13. The powered surfboard system of claim 12, wherein no part of the lever system protrudes below the lower side 14 of the hull when in the latched position.

14. The powered surfboard system of claim 1, wherein an outer surface of the battery pack is configured to be in contact with the surrounding water.

15. The powered surfboard system of claim 14, wherein the battery pack comprises a metal structure configured to conduct heat from a battery comprised in the battery pack to the surrounding water.
